(19) United States
(12) Patent Application Publication
(10) Pub. No.: US 2024/0242148 A1
(43) Pub. Date: Jul. 18, 2024

(54) WORK COORDINATION TOOL

(71) Applicant: Target Brands, Inc., Minneapolis, MN (US)

(72) Inventors: CONNOR HOPKINS HASTING, Plymouth, MN (US); JESSICA LYNN BOTTENSEK, Plymouth, MN (US); HAIDEN ROBERT ROTHWELL, Tucson, AZ (US); ROBERT EUGENE HOOVER, Blaine, MN (US); GRANT PAGE NAFZIGER, Minneapolis, MN (US); MATTHEW CHARLES WITTE, Woodbury, MN (US); KARTHEEK MAREMALLA, Minneapolis, MN (US)

(73) Assignee: Target Brands, Inc., Minneapolis, MN (US)

(21) Appl. No.: 18/097,056

(22) Filed: Jan. 13, 2023

(51) Int. Cl. G06Q 10/0631; G06Q 10/087

(52) U.S. Cl. CPC G06Q 10/06316; G06Q 10/06312; G06Q 10/087

(57) ABSTRACT

A tool for coordinating work is disclosed. In example embodiments, the work coordination tool may receive order data and worker data. In some embodiments, the worker data may relate to workers at a location, and the order data may include a plurality of orders to be fulfilled from the location. The work coordination tool may generate a worker-allocation adjustment based on the worker data and the order data. In some embodiments, the worker-allocation adjustment may indicate that a worker of the location is to perform a task so that orders are fulfilled on time. The work coordination tool may send work data to a mobile application installed on a device associated with one of the workers. The work data may include the worker-allocation adjustment.

### BACKGROUND

A group of workers may perform various tasks. In the retail context, for example, workers at a location may need to perform tasks related to fulfilling orders, managing inventory, interacting with people, and performing other jobs. In some instances, it may be challenging to coordinate worker activity across tasks. For example, a certain task may require many workers during some times but few workers during other times. As another example, it may be challenging or time consuming for workers to communicate amongst themselves and with managers regarding what tasks to perform. Furthermore, sometimes tasks may change in real time as events occur or conditions change.

Some approaches for coordinating worker activity have drawbacks. For example, it may be time consuming for a manager of workers to continuously assign workers to tasks. Such an approach may, in some instances, result in suboptimal worker allocation, as a manager may not have easy access to, or may have limited access to, workflow data when assigning a worker to a task. Additionally, some approaches do not adequately consider data related to individual workers or data related to a particular work location. Furthermore, some approaches may not adequately account for different processes and subtasks that may have to be performed by workers.

### SUMMARY

Aspects of the present disclosure relate to a method and system for coordinating work. In a non-limiting example, the method may include receiving worker data and order data for a location. The method may further include generating, based at least in part on the worker data and order data, work data for the location. In some embodiments, the work data may include a worker-allocation adjustment, which may indicate that a task requires more or fewer workers. In some embodiments, the method may include sending the work data to a mobile application installed on mobile devices associated with the plurality of workers. In some embodiments, the mobile application may display aspects of the work data

In a first aspect, a method for coordinating worker activity is disclosed. the method comprises receiving, at a work coordination tool associated with an enterprise, worker data for a plurality of workers at a location, the worker data including worker activity data that is automatically generated in response to optical scans of items being captured during performance of tasks by the plurality of workers; receiving, at the work coordination tool, task data associated with the location, the task data including order data including a plurality of orders to be fulfilled at the location, wherein an order of the plurality of orders is associated with an order preparation process; based at least in part on the worker data, calculating, at the work coordination tool, a worker efficiency for a task of the order preparation process; based at least in part on the worker efficiency and the order data, generating, at the work coordination tool, a worker-allocation adjustment; and based on the worker-allocation adjustment resulting in a recommended adjustment to a number of workers performing the task, automatically sending, from the work coordination tool, the worker-allocation adjustment to a mobile application installed on a mobile device associated with a worker of the plurality of workers.

In a second aspect, a system for coordinating work is disclosed. The system comprises a work coordination tool associated with an enterprise, wherein the work coordination tool comprises a processor and memory; wherein the work coordination tool is communicatively coupled to a mobile application installed on a mobile device associated with a worker of a plurality of workers at a location; wherein the memory includes instructions that, when executed by the processor, cause the work coordination tool to: receive worker data for the plurality of workers at the location, the worker data including worker activity data that is automatically generated in response to optical scans being captured during performance of tasks by the plurality of workers; receive task data associated with the location, the task data including order data including a plurality of orders to be fulfilled at the location, wherein an order of the plurality of orders is associated with an order preparation process; based at least in part on the worker data, calculate a worker efficiency for a task of the order preparation process; based at least in part on the worker efficiency and the order data, generate a worker-allocation adjustment; and based on the worker-allocation adjustment resulting in a recommended adjustment to a number of workers performing the task, automatically send the worker-allocation adjustment to the mobile application.

In a third aspect, a method for coordinating work is disclosed. The method comprises receiving, at a work coordination tool, worker data for a plurality of workers at a location, the worker data including worker activity data that is automatically generated in response to optical scans of items being captured during performance of tasks by the plurality of workers; receiving, at the work coordination tool, order data, the order data including a plurality of orders, wherein an order of the plurality of orders includes one or more items and is associated with an order preparation process; grouping the plurality of orders into a first group of orders associated with a first order preparation process and second group of orders associated with a second order preparation process; based at least in part on the worker activity data, calculating, at the work coordination tool, a first worker efficiency for a first task of the first order preparation process and a second worker efficiency for a second task of the second order preparation process; based at least in part on the first worker efficiency, generating a first worker-allocation adjustment for the first order preparation process; based at least in part on the second worker efficiency, generating a second worker-allocation adjustment for the second order preparation process; and based on the first worker-allocation adjustment resulting in a recommended adjustment to a number of workers performing the first task, automatically sending work data to a mobile application installed on a mobile device associated with a worker of the plurality of workers, the work data including the first worker-allocation adjustment and the second worker-allocation adjustment.

### BRIEF DESCRIPTION OF THE DRAWINGS

FIG. 1 illustrates an example network environment in which aspects of the present disclosure may be implemented.

FIG. 2 illustrates an example network environment in which aspects of the present disclosure may be implemented.

FIG. 3 illustrates a block diagram of an example architecture of aspects of a work coordination tool.

FIG. 4 is a flowchart of an example method performable by a work coordination tool.

FIG. 5 is a flowchart of an example method for calculating worker efficiency.

FIG. 6 is a flowchart of an example method for generating a worker-allocation adjustment.

FIG. 7 illustrates an example application of aspects of the present disclosure.

FIG. 8 is a flowchart of an example method performable by a mobile application.

FIG. 9A illustrates an example user interface of a mobile application.

FIG. 9B illustrates an example user interface of a mobile application.

FIG. 10 illustrates an example user interface of a mobile application.

FIG. 11 illustrates an example user interface of a mobile application.

FIG. 12 illustrates an example user interface of a mobile application.

FIG. 13 illustrates an example user interface of a mobile application.

FIG. 14 illustrates a block diagram of an example computer system.

### DETAILED DESCRIPTION

As briefly described above, aspects of the present disclosure are directed to methods and systems for coordinating work. In the retail context, for example, aspects of the present disclosure may assist workers at a location (e.g., a store) to fulfill orders or perform other workflow tasks at that location.

In example aspects, a work coordination tool described herein may coordinate activity for a plurality of workers across a plurality of locations. The work coordination tool may be communicatively coupled to a mobile application installed on mobile devices used by the workers. In an illustrative example, the work coordination tool may receive worker data and order data for an example location of the plurality of locations.

In example aspects, the order data includes one or more orders that may be fulfilled from the example location. Each of the one or more orders may include data related to, but not limited to, the following: a customer; one or more items; a deadline; and a delivery method. The customer may be the person or entity that placed the order. The deadline may be the time at which the one or more items must be ready to be picked up or shipped. The delivery method may indicate how items are transported from the location to the customer (e.g., customer pickup or shipment). Depending on the delivery method, workers may perform a different set of tasks to prepare the items of an order (e.g., preparing items for pickup versus preparing items for shipment). In example aspects, the worker data may include data related to one or more workers of the example location. In some embodiments, the worker data may include worker activity data for the workers who are currently working. For example, the worker data may include how much time a worker has worked and an amount of work that the worker has performed.

In example aspects, the work coordination tool may group orders. In some embodiments, one group may include orders that are to be picked up by a customer, while another group may include orders that are to be shipped by a carrier. For each group, the work coordination tool may determine whether the workers are on pace to meet order deadlines. Based on this determination, the work coordination tool may, in some embodiments, generate a worker-allocation adjustment for the group of orders (e.g., add one or more workers, remove one or more workers, or keep the number of workers at the current number).

In some embodiments, the work coordination tool is communicatively connected to a mobile application. In some embodiments, one or more workers at the example location has a mobile device with an instance of the mobile application installed thereon. In some embodiments, the work coordination tool may send work data (e.g., the worker-allocation adjustment, worker data, order data, task data, or other data) to the mobile application. In some embodiments, the mobile application may display the work data on a user interface. In some embodiments, a worker may interact with the mobile application to select or assign work. For example, a worker may select an option to perform a task via an input field of the mobile application. In some embodiments, the mobile application may direct the worker to another mobile application for fulfilling the task. Furthermore, the mobile application may send data to the work coordination tool or to databases coupled to the work coordination tool (e.g., to update worker activity data or order data). For example, in response to detecting that a scanner of the mobile device has captured an optical scan of an item, the mobile application, or another system, may automatically generate worker activity data and send such data to the work coordination tool or to a database coupled to the work coordination tool.

Certain embodiments of the present disclosure have technical features that make them particularly advantageous over existing tools. For example, aspects of the present disclosure may cause a mobile application to provide location-specific, real-time workflow data and to provide interactive input fields and data displays. For example, the work coordination tool may communicate via a mobile application to a plurality of workers at a location, providing them with current and projected work data, thereby reducing, in some embodiments, information and workflow bottlenecks (e.g., needing to go to communicate with a manager to receive work information or assignments). As a result, workers may, in some embodiments, more quickly move from one task to the next and may work on tasks that most need attention from workers. Relatedly, resources spent delegating tasks and sharing information (e.g., manager time) may be saved or allocated elsewhere, improvements that, in some embodiments, may reduce costs and improve operational efficiency more generally. Yet still, embodiments of the present disclosure may improve the percentage of orders that are fulfilled on time, thereby improving the speed and reliability of delivery from an origin location to a destination. Yet still, aspects of the present disclosure allow workers to leverage hardware components of mobile devices when carrying out and coordinating tasks, such as using scanning devices to automatically capture worker activity, touch screens to display workflow notifications and to interact with mobile applications, and network communication devices to interact with other worker mobile devices and to interact with server-side systems and services.

Although in example embodiments of the present disclosure work is coordinated across a number of areas involving orders, it is noted that in some examples, work may be managed across a plurality of different tasks, where only some of those tasks may correspond to orders from customers. For example, tasks at a location may relate to managing inventory, interacting with customers (e.g., performing a check-out task or performing activities related to customer relations), cleaning, performing maintenance tasks, performing administrative tasks, or performing other tasks. As such, a work coordination tool may ensure that orders are timely fulfilled while balancing work task assignment relative to other tasks that may be required at the location.

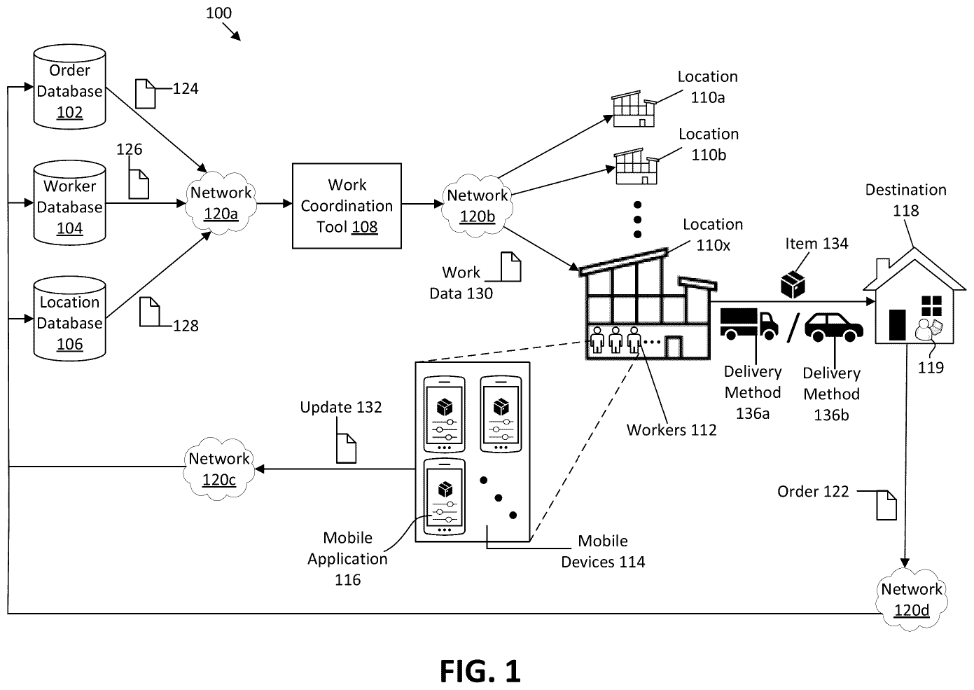

FIG. 1 illustrates an example network environment 100 in which aspects of the present disclosure may be implemented. In the example shown, the example network environment 100 includes a work coordination tool 108, a plurality of databases 102-106, a plurality of locations 110a-x, a plurality of workers 112, each of which may be associated with a mobile device of the worker mobile devices 114, and a destination 118. Furthermore, in the example shown, each of the mobile devices 114 may have a mobile application 116 installed thereon. In the example shown, the example network environment 100 may further include a plurality of networks 120a-d. Furthermore, an example operation of aspects of the present disclosure is illustrated by the elements 122-136.

Referring generally to the databases 102-106, each of the databases 102-106 may, in some embodiments, be associated with a common entity (e.g., they may be managed or used by a common organization, enterprise, or company). Furthermore, in some embodiments, each of the databases 102-106 may be components of a common database or system. For example, each of the databases 102-106 may be part of a common MongoDB. In some embodiments, each of the databases 102-106 may receive data from one or more systems that are not illustrated in the example of FIG. 1. Each of the databases 102-106 and the work coordination tool 108 may include software, hardware, or a combination of software and hardware.

The order database 102 may include data related to a plurality of orders. In some embodiments, an order may include—but is not limited to and need not include—the following: one or more units; one or more customers; one or more times; one or more locations for fulfilling the order; a destination; a delivery method; an order preparation process; metadata; order notes; and other data related to the order or data of the order. In some embodiments, the order database 102 may provide order data 124 (e.g., data from the order database 102) to the work coordination tool 108.

The one or more units of an order may be items (e.g., products sold by a retailer). The one or more times of an order may include the following: a time at which the order was placed; a promised delivery time; a deadline, which may be a time by which a location must have items of the order ready to be picked up or shipped; and other times related to the order or items of the order. The one or more locations for fulfilling the order may include a location (or locations) that have—or will have—one or more items of the order. Example locations include the locations 110a-x. The destination of an order may be a location to which items of an order are sent (e.g., a destination may include an address, and it may be associated with a residence, business, workspace, or other location). In some embodiments, an order may not include a destination (e.g., if a customer is picking up an order). An example destination is the destination 118. The delivery method of an order may indicate how one or more items of an order are transferred to a customer. One example delivery method is order pickup (e.g., a customer picks up on the one or more items from a location). Another example delivery method is order shipment (e.g., a carrier picks up the order and transports it to a destination associated with a customer). Example delivery methods are illustrated as the delivery methods 136a-b. In some embodiments, the preparation process of an order may depend on its delivery method. For example, for customer pickup orders, the order preparation process may include tasks for preparing an order to be picked up. As another example, for shipment orders, the preparation process may include tasks for preparing an order to be shipped. In some embodiments, an order may further contain information related to the customer that placed the order (e.g., customer biographical data, payment data, or instructions left by the customer). In some embodiments, an order may also contain data related to how it was placed (e.g., via a website, via a mobile application, by an internal system, or by some other means).

In some embodiments, the order database 102 may be updated in real time as new orders are placed or as orders are updated. For example, in some embodiments, the order database 102 may receive order data that is automatically generated when a customer submits new orders to an online ordering system. For example, a customer may order one or more items via a website of a retailer, which may cause an online ordering system of the retailer to receive the customer's order and generate order data based on the order, the order data including, for example, the one or more items, customer identification information, a delivery method, and other order data.

In some embodiments, the order data may be part of task data associated with a location. The task data may include data from one or more of the order database 102, the worker database 104, the location database 106, or another database or system. The task data may include data related to tasks that are performed at a location. In some embodiments, the task data may include data related to tasks that are part of an order preparation process, such as picking, packing, putting, or sorting items. Furthermore, the task data may, in some embodiments, include tasks at a location that may not relate to preparing orders, such as tasks related managing inventory, interacting with customers (e.g., performing a check-out task or performing activities related to customer relations), cleaning, performing maintenance tasks, performing administrative tasks, or performing other tasks related to a location. In some embodiments, however, the task data may consist of order data.

The worker database 104 may include data related to workers. Such data may include, in some embodiments, data related to workers of the locations 110a-x. For example, the worker database 104 may include data related to the workers 112 of the location 110x. In some embodiments, the worker database 104 may provide worker data 126 to the work coordination tool 108. In some embodiments, the worker database 104 may receive updates in real time (e.g., as worker activity is captured and sent to the worker database 104, as worker availability or work status changes, as time elapses, or as other events occur). In some embodiments, the worker data 126 may include—but is not limited to and need not include—the following for each worker; the location (or locations) at which the worker works; worker activity data; a work schedule; biographical data; a worker position; worker qualifications; or other data related to a worker.

In some embodiments, the location for a worker may include a location at which the worker is currently working. In some embodiments, the location may also include a location at which a worker may work. The worker activity data may include actions that the worker has performed, as well as data related to those actions. In some embodiments, the worker activity data may be automatically generated based on optical scans of items captured during performance of tasks by workers. For example, the worker activity data may include timestamped actions performed by the worker (e.g., at 9:05:32 AM, Worker A scanned Item 1 of Order ABC as part of a Packing Task, or Worker A began (or completed) a Picking Task for order group XYZ at 12:02:22 PM). In some embodiments, the worker activity data may be aggregated by task or by time. For example, the worker activity data may indicate how many actions within a task that a worker has performed over a time period (e.g., Worker A has packed 140 items over the last 0:45 minutes). In some embodiments, the worker activity data may be activity for a current workday. In some embodiments, the worker activity data may include data from previous days. In some embodiments, the worker activity data may be automatically updated as additional optical scans of items are captured as workers perform tasks. A worker schedule may include hours that the worker is schedule to work as well as locations at which the worker is scheduled to work. In some embodiments, the worker schedule may indicate whether a worker is currently working. Biographical data of a worker may include a worker's name, worker identification number, age, address, etc. A worker's position and qualifications may indicate tasks that a worker is permitted or required to perform. For example, a worker may be a manager, in which case the worker may be permitted to take certain actions using a mobile application described herein (e.g., assign other workers to tasks or view certain analytics data). As another example, a worker may require a qualification to perform certain tasks (e.g., tasks that require the use of machinery or other tasks that require training). As another example, it may be required, depending on local laws, that a worker be least a minimum age to perform certain tasks (e.g., it may be required that a worker be at least twenty-one years old to perform tasks related to alcohol).

The location database 106 may include data related to facilities having items and workers (e.g., the locations 110a-x, as described below). In some embodiments, the location database 106 may provide location data 128 to the work coordination tool 108. The location data 128 may include—but is not limited to and need not include—the following for a location; operating hours; geographical information; location type data; resource data; inventory data; worker data associated with the location; order preparation process data for the location; data related to tasks performed at the location, or other data.

The operating hours for a location may, in some embodiments, include the hours during which a location is open. In some embodiments, the operating hours may include hours during which items are processed in the location or hours during which a customer or carrier may pick up items from the locations. In some embodiments, the operating hours may depend on the day (e.g., the day of the week, the day of the year, or whether it is a holiday). The geographical information may include an address of the location, the geocoordinates of the location, or other information related to a physical location of the location. The location type data of a location may indicate whether the location is, for example, a store, a fulfilment center, a sortation center, a warehouse, or other type of location that may include workers and items. The resource data for a location may include data related to the item processing capacity of the location. For example, the resource data may include a size of the location, a space allocation within the location (e.g., whether a location includes a designated space for a particular task and characteristics of such a space), characteristics of loading or pick up locations (e.g., loading docks, garages, designated pick up spaces), machinery available at the location, or other characteristics of the location that may impact the ability of the location to fulfill orders. The inventory data of a location may include data related to items that are present at the location, or that will be present at the location. In some embodiments, the inventory data may include data from the order database 102. The worker data of a location may include data of workers who work at the location. In some embodiments, the worker data of a location may include data from the worker database 104.

In some embodiments, the order preparation process data for a location may include data related to what order preparation processes are performed at the location and the tasks that make up these processes. For example, the order preparation process data may indicate that, at location 110x, for workers to prepare orders for customer pickup, the workers must pick items of the orders and put them at a place to be picked up. Other locations, however, may include different tasks for preparing orders for customer pick up. Furthermore, in some embodiments, the order preparation process may indicate that, at a location, orders may be prepared to be shipped or delivered in another way.

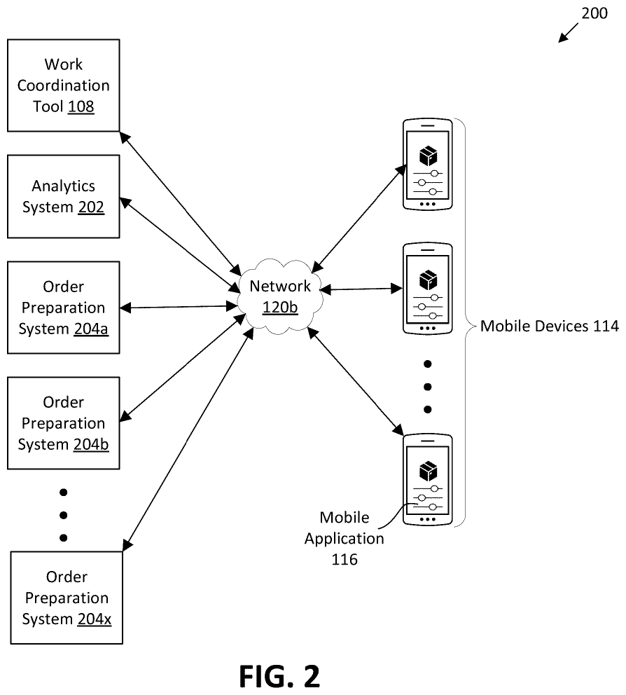

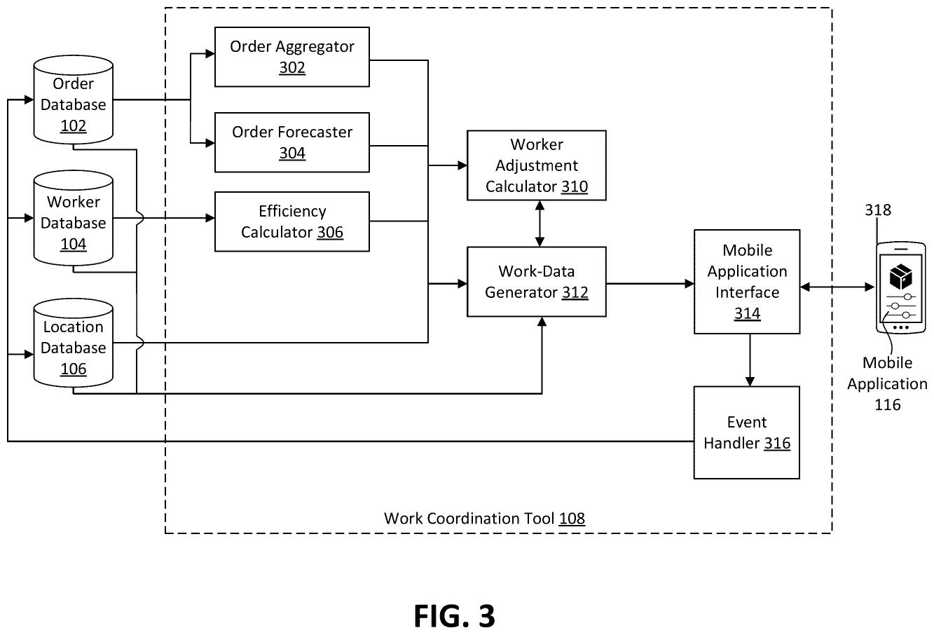

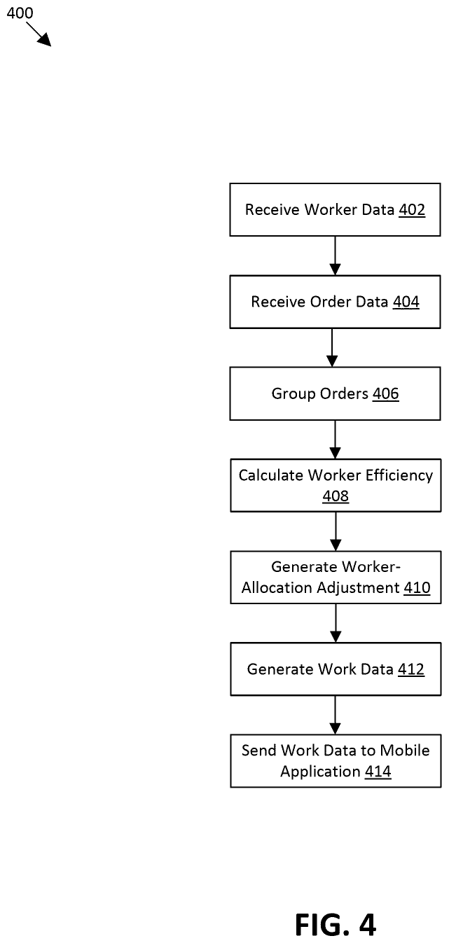

In some embodiments, the work coordination tool 108 may receive one or more of order data 124, worker data 126, or location data 128. In some embodiments, the work coordination tool 108 may receive task data, which may include data from one or more of the databases 124-128, and which may include data related to tasks performed at a location. Based at least in part on the received data, the work coordination tool 108 may coordinate worker activity at the locations 110a-x. For example, the work coordination tool 108 may use the data 124-128 to generate work data 130 and cause the mobile application 116 to display aspects of the work data 130, thereby communicating with the workers 112. Furthermore, in some embodiments, the work coordination tool 108 may allocate—or recommend an allocation of—workers to certain tasks at a location so that work at the location is performed efficiently and completed on time. In some embodiments, the work coordination tool 108 may be communicatively coupled with other systems for fulfilling orders (e.g., systems that facilitate the completion of tasks), as is further described in connection with FIG. 2. Example components of the work coordination tool 108 are described below in connection with FIGS. 3. Furthermore, example methods that may be performed by the work coordination are further described below in connection with FIGS. 4-8.

The locations 110a-110x may be facilities having workers and items. In some examples, the locations 110a-x may be physical locations. In some embodiments, one or more of the locations may have—or may receive-one or more items ordered by a customer. In some embodiments, one or more of the locations 110a-x is a retail store. In some embodiments, one or more of the locations 110a-x is a warehouse, fulfillment center, or a sortation center. In some embodiments, each of the locations 110a-x is associated with a common entity (e.g., each of the locations 110a-x may belong to, or be associated with, a common retailer). Each of the locations 110a-x may include a plurality of workers, such as the workers 112 of the location 110x. In some embodiments, each of the locations 110a-x may be configured so that items may be transferred from the location to a customer. For example, a customer may pick up items from the location. As another example, a third-party carrier (e.g., UPS, USPS, FedEx, DHL, etc.) or another carrier (e.g., a gig worker or a carrier associated with one or more of the locations 110a-x) may pick up items at a location and deliver it to the customer.

In the example of FIG. 1, the workers 112 may be working at the location 110x. The workers 112 may perform one or more tasks, including tasks related to fulfilling orders. Furthermore, in some embodiments, the workers 112 may also perform tasks that may not be related to fulfilling orders. For example, the workers 112 may perform tasks related to, for example, managing inventory, interacting with customers (e.g., performing a check-out task or performing activities related to customer relations), cleaning, performing administrative tasks, or performing other tasks that me be performed at the location 110x. In some embodiments, one or more of the workers 112 may be a manager. In some embodiments, one or more of the workers 112 may be trained or qualified to perform a task that another of the workers 112 is not trained or qualified to perform. In some embodiments, one or more of the workers 112 may use a mobile device, as illustrated by the worker mobile devices 114.

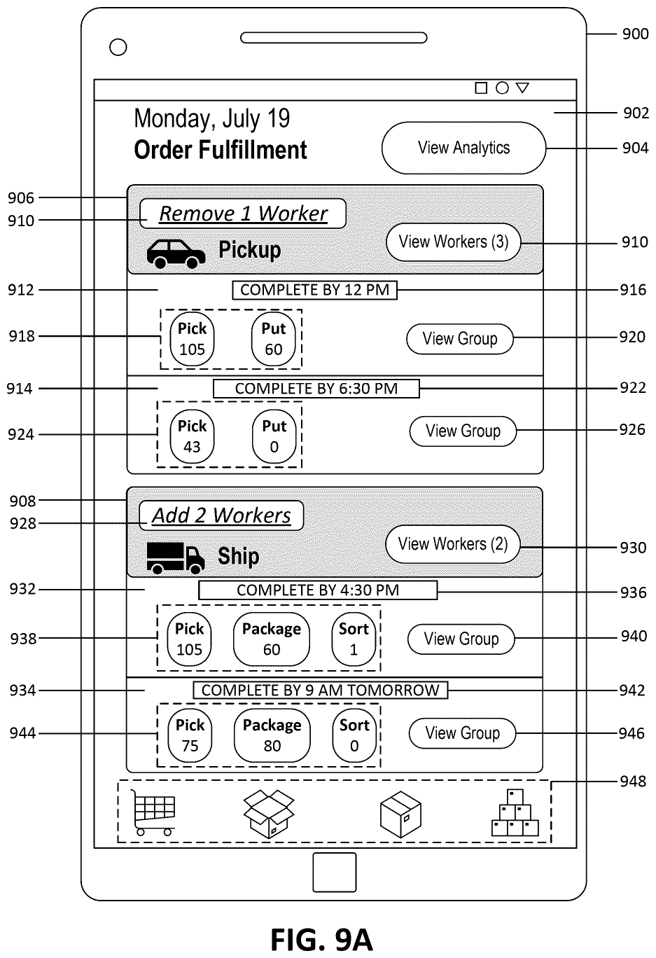

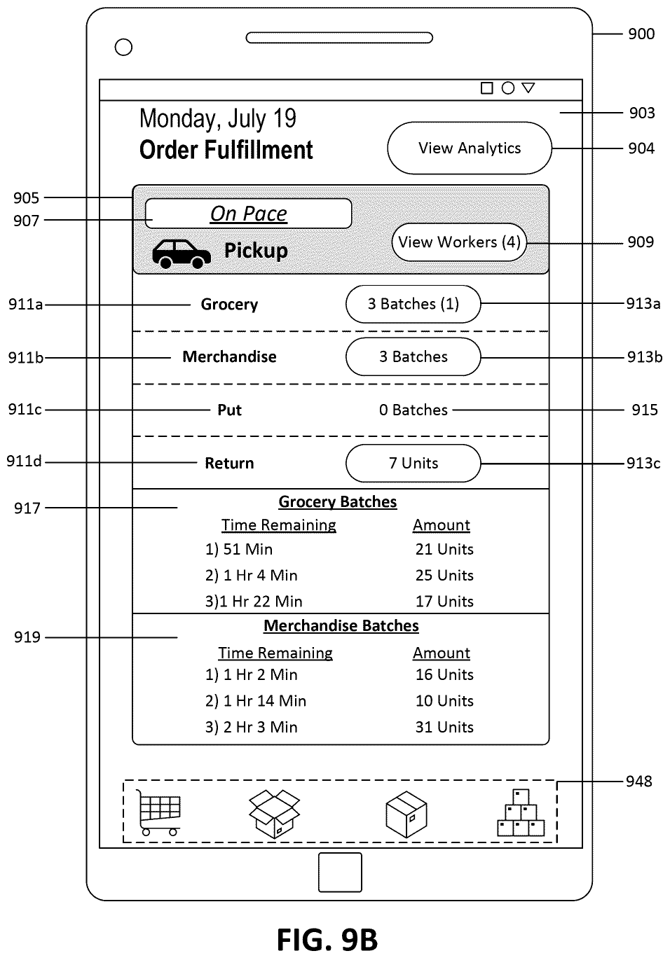

In some embodiments, a mobile device of the mobile devices 114 may be a smart phone, a tablet, or a device configured to facilitate order fulfillment or to perform other tasks. In some embodiments, one or more of the mobile devices 114 may have the mobile application 116 installed thereon. One or more of the mobile devices 114 may also, in some embodiments, include other mobile applications or systems related to order fulfillment that may be communicatively coupled to the mobile application 116. In some embodiments, the workers 112 may use the mobile devices 114 and the mobile application 116 to perform tasks related to fulfilling orders. The mobile application 116 may be associated with the work coordination tool 108. For example, the mobile application 116 may be configured to receive data from the work coordination tool 108 and send data to the work coordination tool 108 (or to systems, such as the databases 102-106, that may be communicatively coupled to the work coordination tool 108). Furthermore, the mobile application 116 and the work coordination tool 108 may be associated with a common entity (e.g., a common organization, enterprise, or company). In some embodiments, the work coordination tool 108 may send the work data 130 to the mobile devices 114 for display by the mobile application 116. In some embodiments, the mobile application 116 may include a plurality of user interfaces, which may display aspects of the work data 130. Furthermore, in some embodiments, the user interfaces may provide interactive input fields that may be used by workers for beginning, ending, or performing order fulfillment tasks. Example user interfaces are further described below in connection with FIGS. 9-13.

In some embodiments, one or more of the workers 112 may carry a mobile device, e.g., mobile device 114, throughout a work shift. In some instances, the mobile device may provide functionality related to various aspects of a worker's day. For example, the mobile device may include functionality (e.g., a mobile application, a calendar or timer function, or another component) for managing a worker's hours or schedule. Furthermore, the mobile device may, in some embodiments, include functionality for coordinating work among workers across a plurality of tasks, and in some embodiments, the mobile device may include functionality for carrying out one or more tasks.

In some embodiments, the mobile application 116 may aggregate data from across systems that a worker may use, and the mobile application 116 may provide navigation tools to access and change between various tools provided by the mobile application 116. For example, the mobile application 116 may guide worker tasks by providing notifications to the user as well as guide screens for performing various tasks (e.g., restocking, order fulfillment, item location/price checking, stock checking, and the like). As a result, the mobile application 116 may improve the speed at which a worker may access information that is relevant to their workday (e.g., workflow data) and the ease by which a worker may switch among functionalities of the mobile application and mobile device. Furthermore, in some embodiments, a worker may use the mobile application 116 to view data from various enterprise software systems in one user interface, or one set of user interfaces, belonging to the mobile application 116, thereby reducing the need for a worker, such as a manager, to rely on multiple systems to view workflow data and manage work.

In some embodiments, the mobile application 116 may provide at least some distinct data or functionality to a manager of a location or to an administrator of the mobile application 116. For example, the mobile application 116 may, in some embodiments, provide to a manager one or more input fields for assigning a worker to a task or for changing a worker from one task to another. Furthermore, a manager may, in some embodiments, view data that may not be displayed to other workers, such as data related to worker efficiency, worker schedules, or analytics data.

In some embodiments, the mobile application 116 may provide data related to a priority of tasks to complete. For example, tasks may be ranked based on one or more of a deadline, an amount of work remaining to be completed for the task, a need for manager or worker attention, or on another metric. In some embodiments, the mobile application 116 may automatically assign work to a worker based on a priority of the work. For example, if a worker selects a button to begin a “Pick” task, then the mobile application 116 may automatically assign to the worker a group of items or orders to be picked that has the highest priority. Furthermore, in some embodiments, the mobile application 116 may activate and deactivate input fields that users may select to work on tasks. For example, if a particular task does not need any additional workers (e.g., because of a low priority of the work within that task), then the mobile application 116 may deactivate an option to work on that task, while activating an option to begin working on other, higher priority tasks.

Furthermore, the mobile devices 114 may include one or more components that may be used by the workers 112 as part of carrying out a task. For example, one or more of the mobile devices 114 may include an optical scanning system. In some embodiments, the optical scanning system may include a scanner, such as a camera or another device that may capture visual information proximate to a mobile device. In some embodiments, the optical scanning system may also include one or more software or hardware components for ingesting the visual information captured by the scanner (e.g., components for translating visual captures of barcodes or QR codes to alpha-numeric data). For example, a worker of the workers 112 may use an optical scanning system of one of the mobile devices 114 to scan a bar code (or QR code or another type of code) of an item or a package. For instance, if the worker is working on a pack task, then the worker may scan a code associated with a packed box. As another example, if a worker is working on a pick task, then the worker may scan a code associated with an item. Still further, the code could be used for other functions, such as a price check or price update, restocking, or other tasks.

In some embodiments, data derived from optical scans of items may cause worker activity data to be automatically captured as workers use the optical scanning system to carry out a task. In some embodiments, time-stamped data may be automatically generated by using data captured with the optical scanning system. In some embodiments, a mobile device, or the mobile application 116, may automatically send such data to one or more systems related to coordinating worker activity, such as the worker database 104 or the work coordination tool 108. In some embodiments, the work coordination tool 108 may use data based on optical scans to determine a worker's current task and to calculate worker efficiency, a process that is further described below.

In some embodiments, automatically generating worker activity data and coordinating work may be performed concurrently, thereby providing real-time workflow adjustments that account for real-time worker activity. For example, a scan of an item by a worker may automatically generate updated worker activity data that is received by the work coordination tool 108. The work coordination tool 108, in turn, may generate updated work data based at least in part on the updated worker activity data. In some embodiments, the work coordination tool 108 may then send the updated work data to workers, who may perform one or more actions in response to receiving the updated work data, such as scanning a code or touching a screen of the mobile to begin a task. In some embodiments, such an action may generate another set of updated worker activity data to send to the work coordination tool 108, which may again generate and send updated work data to the mobile devices 114, and so on.

The destination 118 may be associated with a customer 119 that places an order (e.g., the order 122). In some embodiments, the destination 118 may be a location to which an item is transported from one of the locations 110a-x. The customer 119 may be a person or entity that places an order for one or more items. In some embodiments, the customer 119 may place an order via an online system. In some embodiments, the customer 119, when placing an order, may indicate a delivery method of the one or more items. For example, the customer 119 may indicate that the one or more items are to be shipped, as indicated by the delivery method 136a. As another example, the customer 119 may indicate that the customer will pick up the one or more items, as indicated by the delivery method 136b. In some embodiments, the customer 119 may indicate a time for an order, such as a time by which the customer 119 will pick up an order or a time by which the customer wants to receive the order by shipment. In some embodiments, a system, such as a system coupled to an online ordering system, will determine a time by which the customer can expect to receive a shipped order, based, for example, on item availability, the destination 118, supply chain data, and a delivery time window selected by the customer 119. In some embodiments, if the customer 119 elects to pick up the order, the time to pick up the order may be a default time, such as two hours. The default time may depend, in some embodiments, on the location that is fulfilling the order.

In the network environment 100, the network 120a may communicatively couple the databases 102-106 with the work coordination tool 108. The network 120b may communicatively couple the work coordination tool 108 with the locations 110a-x. The network 120c may communicatively couple the worker mobile devices 114 with the databases 102-106. The network 120d may communicatively couple the customer 119 with the databases 102-106. Each of networks 120a-d may be, for example, a wireless network, a wired network, a virtual network, the Internet, or any other type of network. Furthermore, each of the networks 120a-d can be divided into subnetworks, and the subnetworks can be different types of networks or the same type of network. In different embodiments, the network environment 100 can include a different network configuration than shown in FIG. 1, and the network environment 100 may include more or fewer components than those illustrated.

In the example of FIG. 1, the elements 122-136 illustrate an example application of aspects of the network environment 100. In the example shown, the customer 119 may place an order 122 (e.g., via a website or mobile application of a retailer associated with the location 110x). The order 122 may be sent to a system for fulfilling orders, which may include—or may be communicatively coupled with—one or more of the databases 102-106. For example, the order 122 may be added to the plurality of orders in the order database 102. The order database 102 may, in turn, provide order data 124 (which may include the order 122) to the work coordination tool 108. In some embodiments, the work coordination tool 108 may determine that the order 122 is to be fulfilled by the location 110x. Furthermore, the work coordination tool 108 may receive worker data 126, which may include data related to the workers 112, and the work coordination tool 108 may receive location data 128, which may include data related to the location 110x.

The work coordination tool 108 may generate and send work data 130 to the mobile application 116 for coordinating activity of the workers 112. The work data 130 may include aspects of the data 124-128. In some embodiments, the work data 130 may also include data for tasks that may not be related to fulfilling orders. Furthermore, the work data 130 may include a status for one or more order preparation processes, including a status for a plurality of tasks that make up an order preparation process. In the example of FIG. 1, the work data 130 may include, among other things, data related to the order 122. Furthermore, the work data 130 may include a worker-allocation adjustment for the workers 112 so that orders (e.g., including the order 122) may be ready on time to be picked up or shipped.

As part of fulfilling the plurality of orders, one or more of the workers 112 may use the mobile devices 114 to interact with input fields displayed by the mobile application 116. In some embodiments, the mobile application 116 may send an update 132 to one or more of the databases 102-106 in response to receiving an input from one of the workers 112 (e.g., a worker may indicate that he or she has begun a task, has finished a task, or has otherwise taken an action). The update 132 may cause a change to one or more of the databases 102-106, which may then send the change to the work coordination tool 108. In some embodiments, the mobile application 116 may send the update 132 or other events captured by the mobile application 116 directly to the work coordination tool 108.

As shown in the example of FIG. 1, the item 134 (or items) may be delivered from the location 110x. In some instances, the item 134 may be shipped to the customer 119, as indicated by the delivery method 136a. For example, a carrier may pick up the item 134 and deliver it to the destination 118. In other instances, the item 134 may be prepared by the workers 112 so that it may be picked up at the location 110x, for example by the customer 119, as indicated by the delivery method 136b. The elements 122-136 illustrate one example use of aspects of the present disclosure. In some embodiments, aspects of the present disclosure may coordinate worker activity across a plurality of locations for a plurality of orders and at various times.

FIG. 2 illustrates an example network environment 200 in which aspects of the present disclosure may be implemented. The environment 200 includes the work coordination tool 108, an analytics system 202, order preparation systems 204a-x, the network 120b, and the mobile devices 114. As shown in the example of FIG. 2, the work coordination tool 108 may, in some embodiments, be communicatively coupled with the systems 202-204 and may send them data. In some embodiments, the analytics system 202 may send data to the work coordination tool 108. In some embodiments, one or more of the order preparation systems 204a-x may send data to the work coordination tool 108. In some embodiments, the work coordination tool 108 and the systems 202-204 may be communicatively coupled with the worker mobile devices 114 via the network 120b.

In some embodiments, the systems 202-204 may be accessible using a mobile device of the mobile devices 114. In some embodiments, the systems 202-204 may be accessed via the mobile application 116. For example, the mobile application 116 may include an input field that, when selected, directs a user to the analytics system 202 or to one or more of the order preparation systems 204a-x. In some embodiments, one or more of the analytics system 202 or one of the order preparation systems may itself be a mobile application—or be coupled to a mobile application—that is installed on one or more of the mobile devices 114. In some embodiments, the mobile application 116 may include one or more deep links that, when selected by a user, cause the mobile application 116 to open or display one or more of the analytics system 202 or one or more of the order preparation systems 204a-x.

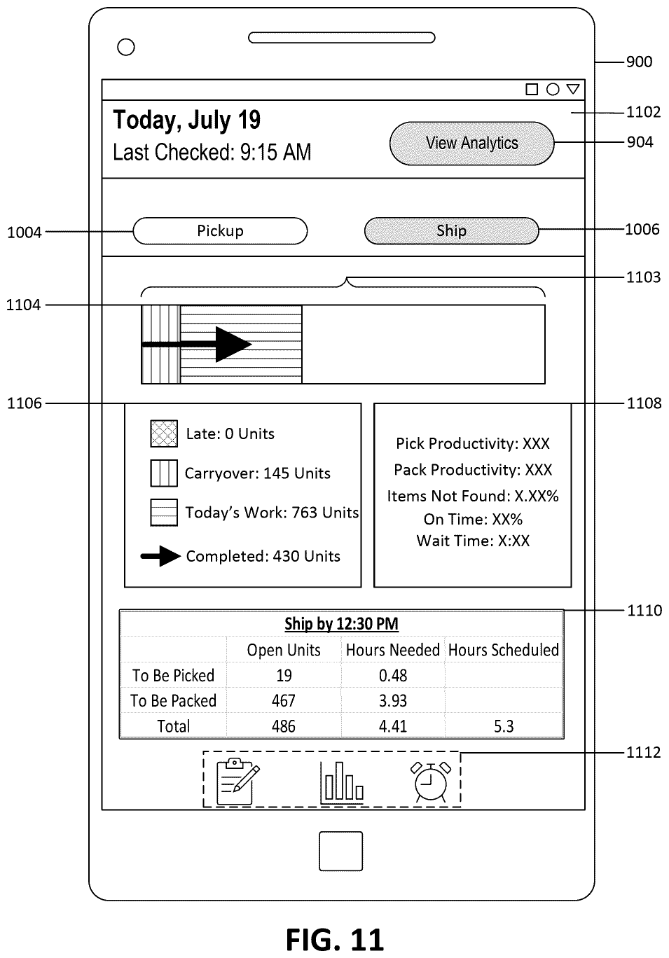

The analytics system 202 may receive order data and worker data from the work coordination tool 108 and, in some embodiments, from other systems. In some embodiments, the analytics system 202 may organize the data (e.g., organize the data by location, by time, by delivery method, etc.). Further, in some embodiments, the analytics system 202 may apply one or more operations to the data to derive one or more metrics or illustrations. For example, the analytics system may determine a number of orders fulfilled over a period of time and determine how this number has changed. In some embodiments, the analytics system may include a current workflow status, which may include a number of orders or items that are forecasted, completed, in progress, late, etc. . . . As another example, the analytics system may determine various measurements of worker efficiency (e.g., worker efficiency by task, worker efficiency by location, worker efficiency over time, etc.). As another example, the analytics system 202 may determine measurements related to timely order preparation or fulfilment (e.g., a percentage of orders timely prepared broken down by order preparation process or percentage of orders timely prepared over time or by location). In some embodiments, the analytics system 202 may include other data or calculations that may be used by the workers 112 or an entity associated with one or more of the locations 110a-x. In some embodiments, the analytics system 202 may be configured to display one or more user interfaces on the worker mobile devices 114. The user interfaces may, in some embodiments, display data received and generated by the analytics system 202. In some embodiments, a user may interact with the user interfaces of the analytics system 202 to, for example, explore, share, or save data. An example user interface of the analytics system is further described below in connection with FIG. 11.

Each of the order preparation systems 204a-x may receive order data and worker data from the work coordination tool 108 and, in some embodiments, from other systems. In some embodiments, the order preparation systems 204a-x may be configured to facilitate a process of preparing an order. In some embodiments, one or more of the order preparation systems 204a-x may facilitate and coordinate the execution of a task that belongs to a process of preparing an order.

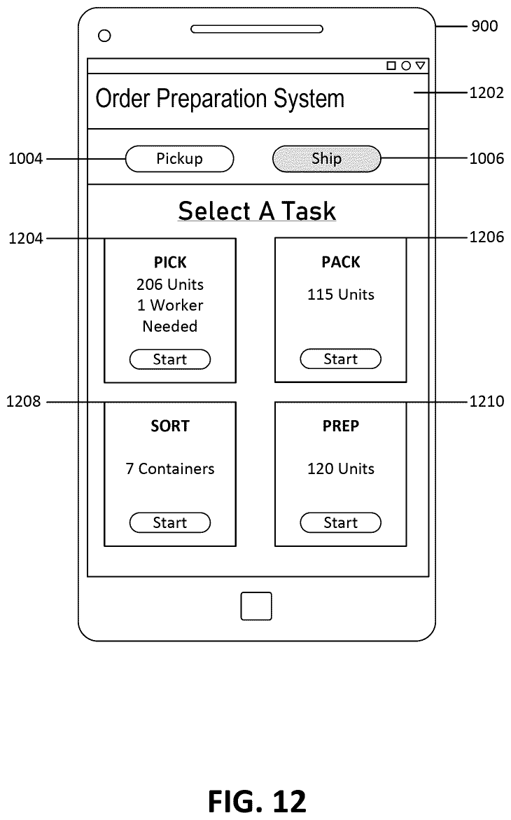

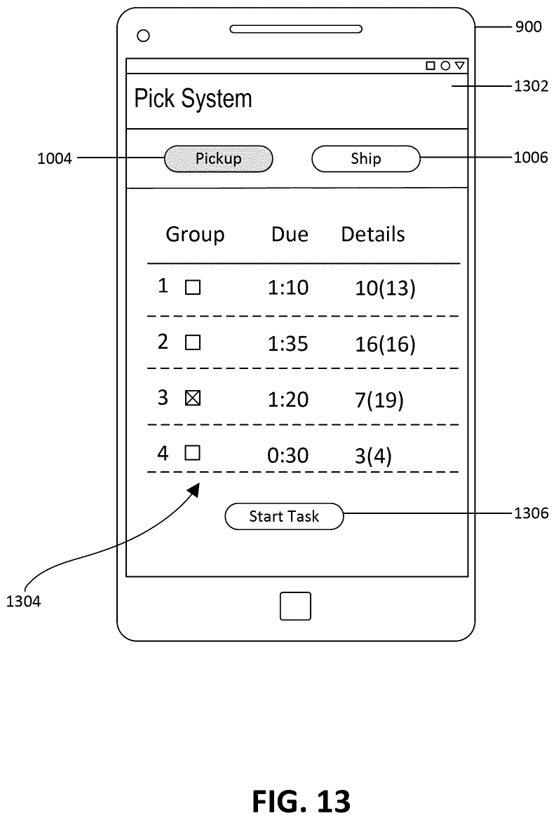

For example, the order preparation system 204a may be an interactive system for picking items of orders, a task that may be part of preparing orders for pick up and/or preparing orders for shipment. In such an embodiment, the order preparation system 204a may include groups of orders having items to be picked. In such an embodiment, the order preparation system 204a may include data related to items that must be picked (e.g., item identification and location data). Furthermore, the order preparation system 204a may include an input field that a user may select to begin picking a group of items. In some embodiments, a worker may then use the order preparation system 204a to complete a picking task. As another example, one of the order preparation systems 204a-x may be an interactive system for packing, putting, or sorting items, or a system for performing another task related to order fulfillment. Examples of order preparation systems 204a-x are further described below in connection with FIGS. 12-13.

FIG. 3 illustrates a block diagram of aspects of an example work coordination tool 108. In the example of FIG. 3, the work coordination tool 108 includes a plurality of components. In some embodiments, the components may include software, hardware, or a combination of software and hardware. Depending on the embodiment, the components, and the interactions between components, may vary. In some embodiments, one or more of the components may be implemented in a computing environment, such as the computing environment 1402, which is further described below. In the example of FIG. 3, the components are described as having certain characteristics and performing certain function. In other examples, the work coordination tool 108 may have different components than those illustrated, and the components may perform different functions.

In the example of FIG. 3, the work coordination tool 108 includes an order aggregator 302, an order forecaster 304, an efficiency calculator 306, a worker adjustment calculator 310, a work-data generator 312, a mobile application interface 314, and an event handler 316. The example of FIG. 3 further includes the order database 102, worker database 104, and location database 106, which are described above in connection with FIG. 1. The example of FIG. 3 further includes a mobile device 318, which may be one of the worker mobile devices 114 of FIGS. 1-2.

The order aggregator 302 may receive order data from the order database 102. For example, the order aggregator 302 may receive a plurality of orders. In some embodiments, the order aggregator 302 may continuously receive order data from the order database as orders are added, completed, or updated. In some embodiments, the order aggregator 302 may receive data from the order database 102 in batches or intervals (e.g., receive order data every thirty seconds, minute, or five minutes). In some embodiments, the order aggregator 302 may group orders of the plurality of orders. In some embodiments, the order aggregator 302 may group orders into batches. In some embodiments, the order aggregator 302 may group orders of the plurality of orders based on characteristics of orders. For example, the order aggregator 302 may group orders based on their delivery method (e.g., via order pickup or by shipping). As another example, the order aggregator 302 may group orders based on a deadline (e.g., a time at which an order must be ready to be picked up by a customer or carrier).

Furthermore, in some embodiments, the order aggregator 302 may sort orders (or may sort groups of order, such as batches) to indicate a priority of work to complete. For example, the order aggregator 302 may sort orders based on a deadline by which they must be ready to be shipped or picked up, by a remaining amount of work required to prepare an order, by a user-defined order priority, by a high priority item of an order, or by another characteristic of an item, order, or a group of orders. For example, an enterprise may, in some instances, determine that orders having a certain item (e.g., a promotional item or an item with a high price) will have priority over other orders, irrespective of deadlines. Thus, an enterprise may, in some instances, use aspects of the present disclosure to improve outcomes (e.g., on-time delivery percentages, customer satisfaction, etc.) for orders having high-priority items. In some embodiments, the work coordination tool 108 may, by sorting orders to determine work priority, determine an order in which work is to be completed at a location. As described below in connection with FIGS. 9A-B, the priority of work may, in some embodiments, determine what work is automatically assigned to workers and may, in some embodiments, determine what tasks are available for a worker to select and begin working.

As another example of grouping orders, the order aggregator 302 may group orders based on the items that make up the orders (e.g., grouping orders that have similar items). In some embodiments, the order aggregator 302 may group orders based on a location (e.g., creating a group of orders that may be fulfilled by a particular location). In some embodiments, the order aggregator 302 may group orders based on a combination of techniques. For example, the order aggregator 302 may create a batch of orders for a particular location that are to be delivered via pickup and that are due before a certain time (e.g., Order Group 1 includes Order A, Order B, and Order C, each of which are to be delivered via customer pickup from Location X and each of which must be ready for pick up before 2:15 PM). In some embodiments, the order aggregator 302 may output one or more groups of order to the worker adjustment calculator 310, to the work-data generator 312, or to another component of the work coordination tool 108.

The order forecaster 304 may receive order data from the order database 102. In some embodiments, the order forecaster 304 may project how many orders may need to be fulfilled. For example, for a given location and for a given day, the order forecaster may project how many orders (or items) that the location will fulfill on that day. In some embodiments, the order forecaster may generate order (or item) forecasts based at least on one or more of the following: actual orders, carryover orders (e.g., orders from a previous day), historical order patterns, or orders that were placed at a previous time and are now ready to be fulfilled. In some embodiments, the order forecaster may output order forecasts to the worker adjustment calculator 310, to the work-data generator 312, or to another component of the work coordination tool 108.

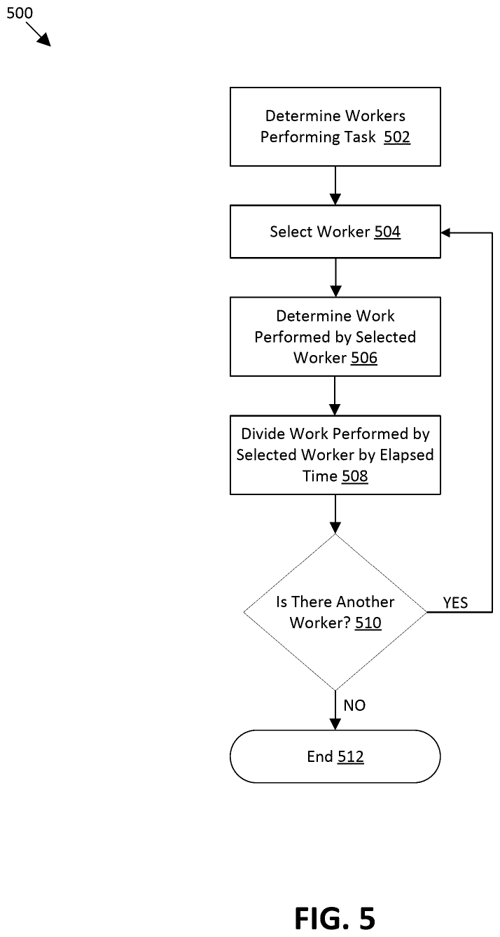

The efficiency calculator 306 may receive worker data from the worker database 104. For example, the efficiency calculator 306 may receive data related to worker activity, including tasks that a worker has performed. In some embodiments, the efficiency calculator 306 may receive worker activity in real time. Example worker activity is described above in connection with FIG. 1. Using worker activity data, the efficiency calculator 306 may calculate an efficiency for one or more workers. In some embodiments, the efficiency calculator 306 may calculate a plurality of efficiencies for a worker (e.g., an efficiency for each of a plurality of tasks). To calculate an efficiency for a task, the efficiency calculator 306 may divide a number of units of work completed by a worker by an elapsed time to complete those units of work. Depending on the task, the unit of work may vary (e.g., if the task is picking or packing items, then a unit of work may be an item or a batch including a plurality of items, whereas if the task is sorting, then a unit of work may be a container). In some embodiments, the efficiency calculator 306 may determine an efficiency for a current day (e.g., the time and work performed by the worker are only for the current workday). In some embodiments, the efficiency calculator 306 may account for previous workdays when calculating efficiency. In some embodiments, the efficiency calculator 306 may only calculate one or more efficiencies for workers that are currently working. The efficiency calculator 306 may output one or more efficiencies to the worker adjustment calculator 310, to the work-data generator 312, or to another component of the work coordination tool 108. An example application of the efficiency calculator is further described below in connection with FIG. 5.

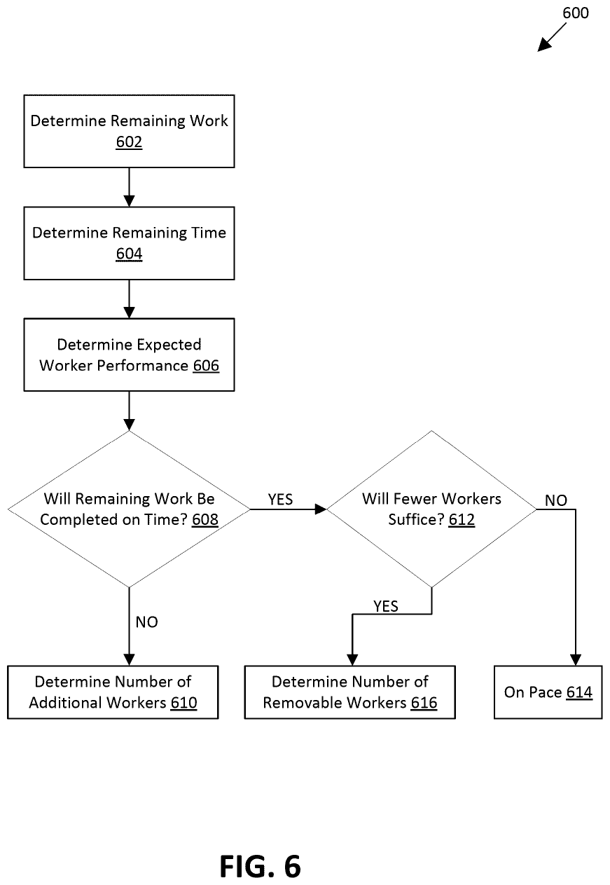

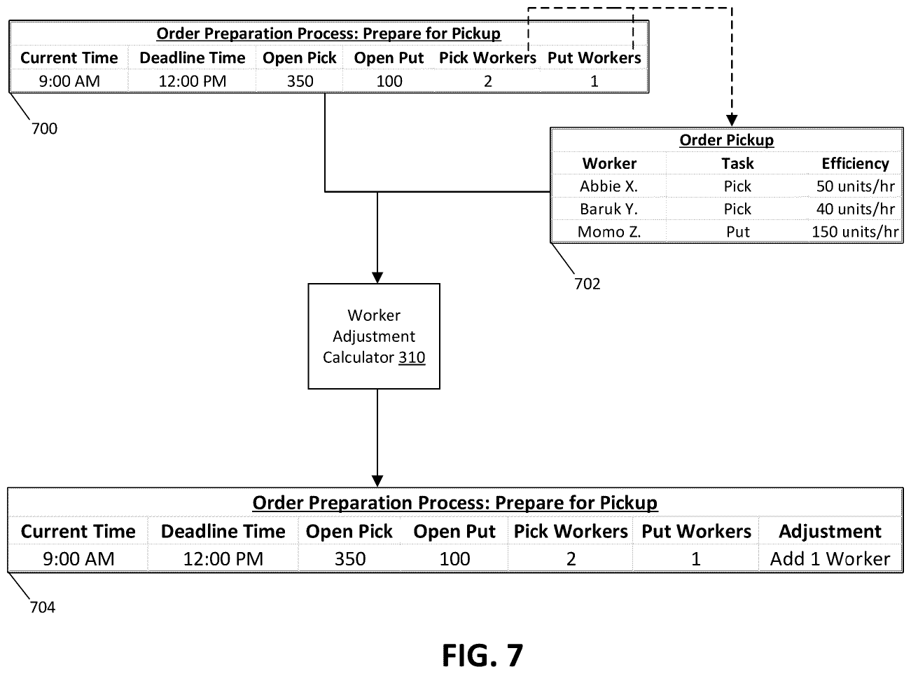

The worker adjustment calculator 310 may receive data from the components 302-306, from the databases 102-106, and from the work-data generator 312. The worker adjustment calculator 310 may, in some instances, generate a worker-allocation adjustment. In some embodiments, the worker-allocation adjustment may be for a location and for an order preparation process (e.g., a worker-allocation adjustment for the location 110x regarding preparing orders for shipment). To generate a worker-allocation adjustment, the worker adjustment calculator 310 may, in some embodiments, use an amount of work remaining and worker efficiencies. For example, the worker adjustment calculator 310 may determine whether a location is on pace to have orders prepared on time. If the location is not on pace to have orders prepared by a deadline, then the worker adjustment calculator 310 may determine how many workers must be added to that order preparation process so that orders will be prepared on time. Furthermore, if the location is on pace to prepare the orders on time, then the worker adjustment calculator 310 may determine whether workers may be removed from the process without resulting in the location not being able to prepare the orders on time. In some embodiments, if the location is either not on pace for a task, or if the location may remove a worker from a task, then the worker-allocation adjustment may be a non-zero number, thereby resulting in a recommended adjustment to a number of workers performing the task. The recommendation may indicate that one or more workers be added to the task or that one or more workers be removed from the task. Furthermore, in some embodiments, the worker adjustment calculator may recommend a particular worker to change tasks in light of a calculated worker-allocation adjustment. Examples of generating worker-allocation adjustments are further described below in connection with FIGS. 6-7. The worker adjustment calculator 310 may, in some embodiments, output one or more worker adjustments to the work-data generator 312.

The work-data generator 312 may, in some embodiments, receive data from at least one or more of the databases 102-106, the components 302-310, or another system. In some embodiments, the work-data generator 312 may select, track, and organize data to generate work data. In some embodiments, the work-data generator 312 may generate a plurality of work data files for a plurality of locations. For example, to generate a work data file for a location, the work-data generator 312 may select and organize data-from a plurality of input sources-that may relate to the location. Furthermore, in some embodiments, the work-data generator 312 may format the data so that it may be received by the mobile application 116 (e.g., the work-data generator 312 may generate a data file having a data format and/or having metadata that is used to communicate with the mobile application 116). In some embodiments, the work-data generator 312 may send work data to the mobile application interface 314. Furthermore, in some embodiments, the work-data generator 312 may send work data to the worker adjustment calculator 310.

As part of generating work data, the work-data generator 312 may, in some embodiments, track a status of one or more order preparation processes at a location. In some embodiments, the work-data generator 312 may track a status of an order preparation process for a group of orders, and this status data may be included in the work data. For example, the work data may indicate that a group of orders is being prepared for customer pickup. Preparing orders for customer pickup may include a plurality of tasks, including, for example, picking items (e.g., locating and collecting items), transporting items, putting items in one or more locations, or performing another task. In some embodiments, the work data may indicate, for that group of orders, how many units of work must be performed for each task (e.g., there may be 20 units, or items, to be picked and another 15 units, or items, to be put in a location). Furthermore, the work data may include status data for preparing orders to be shipped. Preparing orders for shipment may include a plurality of tasks, including, for example, picking items, preparing items, packing items, sorting items or groups of items, or another task. For a group of orders, the work data may include how many units of work are ready to be performed for each task.

The mobile application interface 314 may receive work data (e.g., the work data 130 of FIG. 1) from the work-data generator 312. In some embodiments, the mobile application interface 314 may receive work data for a plurality of locations. In some embodiments, the mobile application interface 314 may receive a plurality of data files that include work data. In some embodiments, the mobile application interface 314 may be configured to communicate with the mobile application 116 on the mobile device 318. In some embodiments, the mobile application interface 314 may be configured to communicate with a plurality of mobile devices (e.g., the mobile devices 114 of FIGS. 1-2). In some embodiments, the mobile application interface 314 may expose an API that, when called by the mobile application 116 causes the mobile application interface 314 to send work data to the mobile application 116. In some embodiments, the mobile application interface 314 may automatically send work data to the mobile application in response to detecting that a worker-allocation adjustment results in a recommended adjustment to a number of workers performing a task at a location. In some embodiments, the mobile application interface 314 may send work data that corresponds with a location associated with the mobile device 318 or a setting of the mobile application 116. Furthermore, the mobile application interface 314 may, in some embodiments, be configured to receive data from the mobile application 116. For example, the mobile application interface 314 may receive updates or events from the mobile application that correspond to user inputs (e.g., a user performing a unit of work or beginning a task). In some embodiments, the mobile application interface may output data received from the mobile application 116 to the event handler 316.

The event handler 316 may receive data from the mobile application 116 via the mobile application interface 314. Based on the received data, the event handler 316 may update one or more of the databases 102-106. For example, the event handler 316 may receive updated worker activity data that is automatically generated based on optical scans captured by workers. Furthermore, in some embodiments, the event handler 316 may update data in one or more of the other components of the work coordination tool 108.

FIG. 4 is a flowchart of a method 400 that may be performed by the work coordination tool 108. Although the work coordination tool 108 may apply aspects of the method 400) to coordinate work for a plurality of locations, in the example of FIG. 4, the method 400 is described in relation to coordinating work for an example location of a plurality of locations. In some embodiments, the work coordination tool 108 may perform the method 400) in response to receiving updated data, such as updated worker or order data.

In the example shown, the work coordination tool 108 may receive worker data (step 402). Example worker data is described above in connection with FIG. 1. In some embodiments, the work coordination tool 108 may request worker data from the worker database 104. In some embodiments, the work coordination tool 108 may receive worker data, or updated worker data, in response to a change to one or more aspects of the worker data (e.g., a change to work activity, such as a new timestamped event generated in response to an optical scan of an item). In some embodiments, the work coordination tool 108 may receive updated worker data in response to a passage of time (e.g., a minute), thereby creating time intervals between receiving worker data. In some embodiments, the work coordination tool 108 may receive only updated aspects of worker data (e.g., one or more data entries related to recent worker activity), and the work coordination tool 108 may integrate such updated data with previous worker data. In some embodiments, the work coordination tool 108 may receive worker data from an instance of the mobile application 116 (e.g., an event captured and sent by the mobile application related to worker activity).

In the example shown, the work coordination tool 108 may receive order data (step 404). Example order data is described above in connection with FIG. 1. In some embodiments, the work coordination tool 108 may receive task data, which may include the order data as well as data related to other tasks. In some embodiments, the work coordination tool 108 may request order data from the order database 102. In some embodiments, the work coordination tool 108 may receive order data, or updated order data, in response to a change to one or more aspects of the order data (e.g., one or more new orders, a completed order, or an altered order). In some embodiments, the work coordination tool 108 may receive updated order data in response to a passage of time (e.g., a minute), thereby creating time intervals between receiving order data. In some embodiments, the work coordination tool 108 may receive only updated aspects of order data (e.g., one or more data entries related to recent order changes), and the work coordination tool 108 may integrate such updated data with previous order data. In some embodiments, the work coordination tool 108 may receive order data from an instance of the mobile application (e.g., the mobile application may determine, based on a user input, that an order has been completed, or that a task related to an item of an order has been completed).

In the example shown, the work coordination tool 108 may group orders (step 406). In some embodiments, the work coordination tool 108 may use the order aggregator 302 to group a plurality of orders of the order data into one or more groups, as described above in connection with FIG. 3. As a result, the work coordination tool 108 may have two or more groups of orders. In some embodiments, the two or more groups may include one or more groups including orders that are to be picked up by customers and one or more groups of orders that are to be shipped.

In the example shown, the work coordination tool 108 may calculate worker efficiency (step 408). In some embodiments, the work coordination tool 108 may calculate a plurality of work efficiencies (e.g., a work efficiency for each of a plurality of workers). Furthermore, in some embodiments, the work coordination tool 108 may calculate a plurality of efficiencies for a worker (e.g., an efficiency for a plurality of tasks). In some embodiments, the work coordination tool 108 may use the efficiency calculator 306 to calculate one or more efficiencies for each worker of a plurality of workers at a location, as described above in connection with FIG. 3. Furthermore, an example method for calculating worker efficiency is illustrated and described below in connection with FIG. 5.

In the example shown, the work coordination tool 108 may generate a worker-allocation adjustment (step 410). In some embodiments, the work coordination tool 108 may generate a plurality of worker-allocation adjustments (e.g., a work-allocation adjustment for each of a plurality of order preparation processes). In some embodiments, the work coordination tool 108 may use the worker adjustment calculator 310 to generate one or more worker-allocation adjustments, as described above in connection with FIG. 3. Furthermore, in some embodiments, the work coordination tool 108 may select one or more workers to associate with a worker-allocation adjustment. For instance, if the worker-allocation adjustment indicates that one additional worker is required for a task, the work coordination tool 108 may, in some embodiments, select a particular worker to add to the task, based, for example, on one or more of that worker's availability, historical activity (e.g., experience or efficiency), on that worker's current task, or on another consideration. As a result, the work coordination tool 108 may specify particular workers to change, for example, from a task that is unrelated to order fulfillment to an order fulfillment-related task that requires more workers to ensure that orders are fulfilled on time. Furthermore, the work coordination tool 108 may indicate one or more specific workers to change between tasks related to order fulfillment or one or more workers to remove from an order fulfillment-related task to another task to perform at a location. Examples of generating worker-allocation adjustments are further described below in connection FIGS. 6-7.

In the example shown, the work coordination tool 108 may generate work data (step 412). In some embodiments, the work coordination tool 108 may use the work-data generator 312 to generate work data, as described above in connection FIG. 3 In some embodiments, the work data may include aspects of one or more of the order data, worker data, location data, or one or more worker-allocation adjustments. Furthermore, in some embodiments, the work data may include status data for each of a plurality of order preparation processes. Such status data may include, in some embodiments, units of work to perform for each of a plurality of tasks of an order preparation process. In some embodiments, the work data may further include data related to tasks that may not be part of an order preparation process. Tasks that may not be related to an order may include, for example, tasks related to managing inventory (e.g., stocking shelves), interacting with customers (e.g., performing a check-out task or performing activities related to customer relations), cleaning, performing maintenance tasks, performing administrative tasks, or performing other tasks that me be performed at a location. In some examples, aspects of the work data may be displayed by a mobile application on a mobile device of a worker. In some embodiments, the work data may be tailored for a particular location (e.g., including orders to be fulfilled by that location, work data for workers at that location, work-allocation adjustments for processes at that location, statuses of order preparation processes for that location, etc.).

In the example shown, the work coordination tool 108 may send work data to a mobile application associated with the work coordination tool 108 (step 414). In some embodiments, the work coordination tool 108 may use the mobile application interface 314 to send the work data to the mobile application, as described above in connection with FIG. 3. In some embodiments, the work coordination tool 108 may send data to the mobile application in response to a call of an API of the work coordination tool 108. In some embodiments, the work coordination tool 108 may automatically send work data to the mobile application in response to detecting that a worker-allocation adjustment results in a recommended adjustment to a number of workers performing a task (e.g., one or more workers are required for an order fulfillment process to be timely completed or one or more workers may be removed from an order fulfillment process). In some embodiments, the work coordination tool 108 may automatically generate and send work data to the mobile application in response to receiving a change to one or more of worker data (e.g., updated worker activity data generated based at least in part by a worker scanning an object as part starting or fulling a task), order data (e.g., a new order placed by a customer), location data (e.g., updated location hours), or other changed data.

FIG. 5 is a flowchart of an example method 500, aspects of which may be performed by the work coordination tool 108. In some embodiments, the work coordination tool 108 may use the work efficiency calculator 306 to perform aspects of the method 500. In some embodiments, aspects of the method 500 may be used to perform at least part of calculating worker efficiency (e.g., step 408 of FIG. 4). As described above, the work coordination tool 108 may calculate a plurality of worker efficiencies. For instance, the work coordination tool 108 may calculate a task-specific work efficiency for a plurality of tasks. Furthermore, the work coordination tool 108 may calculate a work efficiency (e.g., a task-specific work efficiency) for a plurality of workers. In the example of FIG. 5, the work coordination tool 108 may select a task for which to calculate worker efficiencies (e.g., picking items for order pick up, picking items for order shipment, packing items, transporting items, sorting items, putting items in one or more locations, or another task related to order preparation or fulfillment). Furthermore, in some embodiments, aspects of the method 500 may be repeated to determine worker efficiencies for a plurality of tasks. In some embodiments, the work coordination tool 108 may repeat aspects of the method 500 in response to receiving updated worker activity data, thereby updating worker efficiencies. In some embodiments, the work coordination tool 108 may repeat aspects of the method 500 in response to a passage of time.

In the example shown, the work coordination tool 108 may determine workers performing a selected task (step 502). For example, the work coordination tool 108 may determine the identities (e.g., names or worker identifiers) of workers performing the task. In some embodiments, the work coordination tool 108 may determine which worker are currently performing the selected task based on worker activity data that is automatically generated in response to optical scans being captured by workers fulfilling tasks. In some embodiments, the work coordination tool 108 may also determine which workers are currently performing and may be capable of performing the selected task, but which are not currently performing the task. In some embodiments, the work coordination tool 108 may, to determine the workers performing the selected task, use worker data, including worker activity data, which may include data related to a most recent action performed by a worker or a most recent task started by a worker.

In the example shown, the work coordination tool 108 may select one of the workers performing the selected task (step 504). In some embodiments, selection of one of the workers may be included in selection of more than one worker for analysis, for example two or more workers performing the same work task.

In the example shown, the work coordination tool 108 may determine work performed by the selected worker (step 506). To do so the work coordination tool 108 may, in some embodiments, determine a number of units of work performed by the worker since the worker started on the selected task. In some embodiments, the units of work may be measured differently depending on the task. For example, if the task is picking items, then a unit of work may be a single item. In some embodiments, if the task is picking items, then a unit of work may be one or more items (e.g., five small or easy-to-locate items may constitute a unit of work, while just one bigger or harder-to-locate item may constitute a unit a work). As another example, if the task is sorting, then a unit of work may be a container of items or boxes to sort (into or out from). As another example, if the task is transportation, then a unit of work may be a pallet of objects.

In the example shown, the work coordination tool 108 may divide the work performed by the selected worker by the time taken by the selected worker to perform the work (step 508). In some embodiments, the work coordination tool 108 may determine the time required to perform the work by subtracting a time that the selected task was started by a worker from a current time. In some embodiments, other data may indicate how long a worker has been working on a task or how long a worker has taken to complete the work that the worker has performed. As a result of dividing the work performed by time required to perform it, the work coordination tool 108 may have a work efficiency for the selected work for the selected task.

In the example shown, the work coordination tool 108 may determine whether there is another worker that is performing the selected task and for which the coordination tool 108 does not have an updated worker efficiency (decision 510). In response to determining that there is another such worker (e.g., taking the “YES” branch), the work coordination tool 108 may proceed to select another worker (e.g., thereby returning to step 504). In response to determining that there is not another such worker (e.g., taking the “NO” branch), the work coordination tool 108 may end the method 500 (e.g., proceeding to the End step 512), thereby returning, in some embodiments, to perform aspects of the method 400 (e.g., proceeding to the step 410).

FIG. 6 is a flowchart of an example method 600, aspects of which may be performed by the work coordination tool 108. In some embodiments, the work coordination tool 108 may use the worker adjustment calculator to perform aspects of the method 600. In some embodiments, aspects of the method 600 may be used to perform at least part of generating a worker-allocation adjustment (e.g., step 410 of FIG. 4). As described above, the work coordination tool 108 may generate a plurality of worker-allocation adjustments (e.g., a worker allocation adjustment for each of a plurality of order preparation processes at each of a plurality of locations). In the example of FIG. 6, however, the method 600 is described as generating a worker-allocation adjustment for an example order preparation process (e.g., preparing orders for pickup or preparing orders for shipment). In some embodiments, aspects of the method 600 may be repeated to determine a plurality of worker-allocation adjustments. In some embodiments, the work coordination tool 108 may repeat aspects of the method 600 in response to receiving updated worker activity data (e.g., a worker beginning to work on a task of an order preparation process) or in response to receiving updated order data (e.g., one or more new orders). In some embodiments, the work coordination tool 108 may repeat aspects of the method 600 in response to a passage of time. An example application of the method 600 is illustrated and described in connection with FIG. 7.

In the example shown, the work coordination tool 108 may determine an amount of remaining work required to complete a particular collection of tasks, for example, to prepare a group of orders (step 602). To do so, the work coordination tool 108 may, in some embodiments, determine how much work is required to complete each task of the collection of tasks. For example, the work coordination tool 108 may determine how much work is required to complete each task of an order preparation process. The amount of work required to complete a task may, in some embodiments, include both work that may currently be performed in the task and work that will be required to perform in the task. For example, an example order preparation process for preparing orders for shipment may include two tasks: picking items and packing items. In such an order preparation process, items may first be picked and then be packed. Continuing with the example, a unit of work may be defined as one item. Furthermore, for a group of orders there may be 20 items that currently may be picked, and there may be 10 items that currently may be packed. For such an example, the work coordination tool 108 may determine that there are 50 units of remaining work for this group (e.g., 20 items to pick and 30 items to pack, including the 10 items that currently may be packed and the 20 items that will need to be packed once they are picked). In some embodiments, the work coordination tool 108 may determine task-specific remaining work. For example, the work coordination tool 108 may determine that there are 20 units of work to pick and 30 units of work to pack and may not, in some embodiments, combine units of work from different tasks.

In some embodiments, units of work may be defined differently than as a one-to-one correspondence between units of work and items. For example, for an example order preparation process, 20 items may be batched as a unit of work, 1 container (e.g., for a sorting task) may be a unit of work, and 3 pallets (e.g., for a transportation task) may be a unit of work. Furthermore, in some embodiments, I heavy item may be a unit of work, whereas five light items (or five items of the same product) may be a unit of work.

In the example shown, the work coordination tool 108 may determine an amount of remaining time to prepare a group of orders (step 604). In some embodiments, a group of orders may have a deadline, which may be a time by which items of the group of orders must be ready to be picked up or shipped. In some embodiments, the work coordination tool 108 may determine the remaining time based on a difference between the current time and the deadline time.

In the example shown, the work coordination tool 108 may determine an expected worker performance for the group of orders (step 606). In some embodiments, the work coordination tool 108 may determine one or more workers who are working on preparing the group of orders (e.g., working on one or more tasks to prepare the orders). Furthermore, in some embodiments, the work coordination tool 108 may determine efficiencies for the workers who are working on the group of orders. In some instance, these efficiencies may be specific to the task that a worker is currently performing. In some embodiments, the work coordination tool 108 may, for each worker who is working on the group of orders, multiple that worker's efficiency by the amount of time remaining, thereby determining an amount of expected work of that worker. Furthermore, the work coordination tool 108 may, in some embodiments, add together the expected work of each of the workers who is working on the group of orders.

In the example shown, the work coordination tool 108 may determine whether the remaining work will be completed on time (decision 608). In some embodiments, the work coordination tool 108 may compare the amount of remaining work for the group of orders with the expected worker performance for the group of orders. In some embodiments, if the expected worker performance for the group of orders is greater than or equal to the remaining work, then the remaining work may be completed on time. On the other hand, in some embodiments, if the expected worker performance for the group of orders is less than the remaining work, then the remaining work may not be completed on time. In response to determining that the remaining work will be completed on time (e.g., taking the “YES” branch), the work coordination tool 108 may proceed to determining whether fewer workers will suffice (e.g., the decision 612). In response to determining that the remaining work will not be completed on time (e.g., taking the “NO” branch), the work coordination tool 108 may proceed to determining a number of additional workers (e.g., step 610).

In the example shown, the work coordination tool 108 may determine a number of additional workers to complete the work on time (step 610). In some embodiments, the work coordination tool 108 may determine a work shortfall (e.g., how many units of work would not be complete on time if no workers were added or removed). In some embodiments, the work shortfall may equal the remaining work minus the expected worker performance. Furthermore, in some embodiments, the work coordination tool 108 may determine how many workers would be required to perform the work shortfall in the remaining time. To do so, the work coordination tool 108 may, in some embodiments, use an average worker efficiency (e.g., based on historical data) or, in some embodiments, the work coordination tool 108 may use one or more efficiencies of possible additional workers (e.g., workers at the location who may be added to work on the group of orders). As an example, if the work shortfall is 400 units, if the remaining time is 2 hours, and the efficiency of an additional worker is 100 units per hour, then the work coordination tool may determine that 2 additional workers may be required to start working on preparing the group of orders for the orders to be ready on time. In other embodiments, the work coordination tool 108 may use other operations to determine a number of additional workers. For example, in some embodiments, the work coordination tool 108 may use a machine learning model that may account for one or more of location data, worker data, order data, a status of an order preparation process, or external data to predict how many additional workers are required.

In the example, shown, the work coordination tool 108 may determine whether fewer workers will suffice (decision 612). In some embodiments, the work coordination tool 108 may determine whether the remaining work will be completed even if one or more workers are removed from working on the group of orders. For example, the work coordination tool 108 may determine how much greater the expected worker performance is than the remaining work. In some embodiments, the work coordination tool 108 may subtract the remaining work from the expected worker performance to determine an excess work. In some embodiments, if the excess work is greater than the expected work of one or more workers who are working on the group of orders, then the work coordination tool 108 may determine that fewer workers will suffice to complete the work on time. In some embodiments, the work coordination tool 108 may execute one or more simulations with fewer workers to predict whether fewer workers will suffice. In some embodiments, the work coordination tool 108 may use a machine learning model to predict whether fewer workers will suffice. In response to determining that fewer workers will suffice, the work coordination tool may determine how many workers may be removed (e.g., taking the “YES” branch to step 616). In response to determining that no workers may be removed without causing the group of orders to be prepared late, the work coordination tool 108 may determine that the workers are on pace to prepare the group of order (e.g., taking the “NO” branch to step 614). If the workers are on pace, then the worker-allocation adjustment may be zero in some embodiments.

In the example shown, the work coordination tool 108 may determine the number of removable workers (step 616). For example, the work coordination tool 108 may-having determined that, even with fewer workers, the group of orders will be prepared on time-determine how many workers may be removed. To do so, the work coordination tool 108 may, in some embodiments, subtract the expected work of one or more workers from an excess work, and if the result is not negative, then the worker may be removed. In some embodiments, the work coordination tool 108 may calculate an effect of removing various combinations of workers to determine a number of workers that may be removed. In some embodiments, the work coordination tool 108 may determine a number of removable workers in a different way. For example, in some embodiments, the work coordination tool 108 may use a machine learning model that may account for one or more of location data, worker data, order data, a status of an order preparation process, or external data to predict how many workers may be removed.

FIG. 7 illustrates an example of generating a worker-allocation adjustment. The example of FIG. 7 includes the worker adjustment calculator 310, data 700, efficiency data 702, and data 704. In some embodiments, each of the worker adjustment calculator 310, the data 700, the efficiency data 702, and the data 704 may be components of the work coordination tool 108.

The data 700 may include data for a group of orders. As illustrated, the group of orders is to be prepared for order pickup. Furthermore, the current time is 9:00 AM, the deadline by which the orders must be prepared is 12:00 PM, there are 350 units that are ready to be picked, there are 100 units that are ready to be put to a location, there are two workers working on the picking task, and there is one worker working on the put task. In the example, shown, one unit may be equivalent to one item. The efficiency data 702 includes worker efficiency for the plurality of workers who are working on the group of orders associated with the data 700. As shown, the efficiency data 702 includes worker identifications (e.g., names), a task that a worker is currently working on, and an efficiency for that task. In the example shown, there are two workers who are working on the pick task, one worker having an efficiency of 50 units per hour and another worker having an efficiency of 40 units per hour. Furthermore, in the example shown, there is one worker who is working on the put task with an efficiency of 150 units per hour. As described above, the work coordination tool 108 may, in some embodiments, calculate such worker efficiencies based on real-time worker activity.

In the example shown, the worker adjustment calculator 310 (or another component of the work coordination tool 108) may receive the data 700 and the worker efficiency 702. Based at least in part on such data, the work coordination tool 108 may output the data 704, which may include a worker-allocation adjustment. In some embodiments, the worker adjustment calculator 310 may apply aspects of the method 600. For example, the worker adjustment calculator 310 may determine that there are 350 units of work remaining to pick and 450 units of work remaining to put. Furthermore, the worker adjustment calculator 310 may determine that three hours remain until the orders must be ready. Furthermore, the worker adjustment calculator 310 may determine that the expected worker performance for Abbie X. is 150 units, the expected worker performance for Baruk Y. is 120 units, and the expected worker performance for Momo Z. is 450 units. In some embodiments, the worker adjustment calculator 310 may combine tasks to determining a total amount of work remaining and a total expected worker performance. In other embodiments, however, the worker adjustment calculator 310 may operate on task-specific remaining work and expected worker performance. In the example shown, the worker adjustment calculator 310 may determine that the remaining work for the pick task (e.g., 350) is greater than the expected worker performance for the pick task (e.g., 270). As a result, the worker adjustment calculator 310 may determine that one or more workers must be added to work on the group of orders in order to meet the deadline. Furthermore, in the example shown, the worker adjustment calculator may determine that the work shortfall is 80 units. In some embodiments, the worker adjustment calculator may determine, based on an average worker efficiency for the pick task or based on a measured worker efficiency of a particular worker for the pick task, that only one additional worker is required, as illustrated by the data 704.

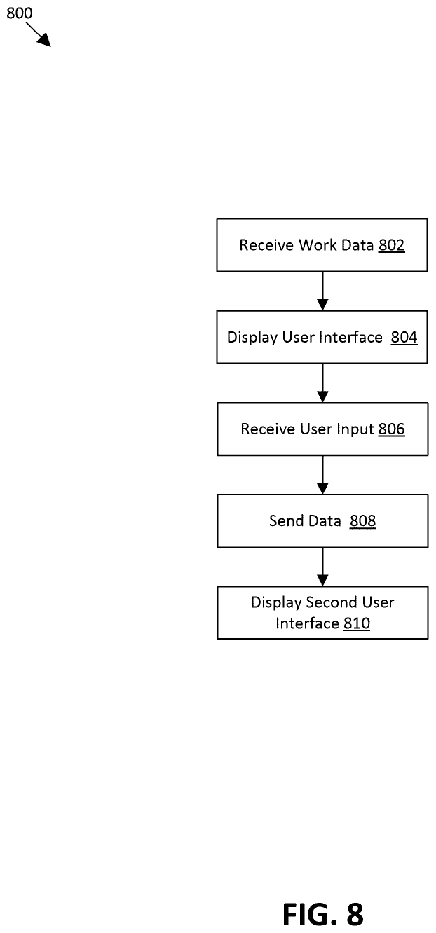

FIG. 8 illustrates a flowchart of an example method 800, which may, in some embodiments, be performed by an instance of the mobile application 116. In the example of FIG. 8, the mobile application 116 may be installed and running on a mobile device associated with a worker at a location.

In the example shown, the mobile application 116 may receive work data (step 802). In some embodiments, the mobile application 116 may call an API of the work coordination tool 108 to receive work data. As described above, the work data may, in some embodiments, be specific to a location associated with the mobile device on which the instance of the mobile application 116 is running. In some instances, the work data may consist of updates related to one or more of orders, workers, statuses of order preparation processes, or other data used by the mobile application 116.

In the example shown, the mobile application 116 may display a user interface (step 804). In some embodiments, the user interface may include aspects of the worker data and one or more input fields for interacting with a worker. In some embodiments, the mobile application 116 may automatically display a notification in response to receiving a worker-allocation adjustment of the work data. The notification may indicate that the worker-allocation adjustment results in a recommendation to adjust a number of workers performing a task. In some embodiments, the notification may include the worker-allocation adjustment and a task that may need more or fewer workers. In some embodiments, the notification may be displayed in the user interface of the mobile application 116, the notification may be displayed on a home screen of a mobile device, or the notification may be a push notification. In some embodiments, the mobile application 116 may display a plurality of user interfaces. Example user interfaces of the mobile application 116 are further illustrated and described below.

In the example shown, the mobile application 116 may receive a user input (step 806). In some embodiments, the mobile application 116 may receive an input via one of the input fields of a displayed user interface. In some embodiments, the user input may be one or more of, but is not limited to, the following: a selection to view order details or details for a group of orders; a selection to view details of one or more workers; a selection to view analytics; a selection to begin a task or to begin working on an order preparation process; a communication to the work coordination tool 108; a selection to access another mobile application or another component of the mobile application 116; a selection to toggle between order preparation processes; a communication with another instance of the mobile application 116; an indication that a unit of work is complete or that a task is complete; or another input or event that may be received by the mobile application 116.

In the example shown, the mobile application 116 may send data (step 808). In some embodiments, the mobile application 116 may send data related to a user input or in response to an event detected by the mobile application 116. For example, the mobile application 116 may send data related to worker activity (e.g., timestamped data entries that indicate one or more actions from one or more workers), or the mobile application 116 may send data indicating that aspects of an order or an order preparation process have changed (e.g., that a unit of work has been picked and is now ready to be packed). In some embodiments, the mobile application 116 may send data to the work coordination tool 108. In some embodiments, the mobile application 116 may send data to other systems (e.g., one or more of the databases 102-106 or one or more of the systems 202-204).

In the example shown, the mobile application 116 may display a second user interface (step 810). In some embodiments, the mobile application 116 may display the second user interface in response to a user input. In some embodiments, the second user interface may provide more detail on one or more of orders, workers, the location, or aspects of one or more of the order preparation processes. In some embodiments, the second use interface may provide a user with options or data for selecting or performing a task. In some embodiments, the second user interface may provide options or data for communicating with another instance of the mobile application 116 (e.g., communicating with another worker) or communicating with the work coordination tool 108. In some embodiments, the second user interface may be the same user interface as the user interface displayed in connection with the step 804 but with updated data. Example user interfaces are illustrated and described below.

FIG. 9A illustrates a mobile device 900, which may be one of the mobile devices 114. An instance of the mobile application 116 may be installed and running on the mobile device 900. In the example shown, the mobile application displays the user interface 902. In some embodiments, the user interface 902 may display aspects of work data for a location. The user interface 902 includes a view analytics input field 904 (e.g., a button). In response to a selection of the analytics input field 904, the mobile application 116 may direct a user to an analytics system, an example of which is described in connection with the analytics system 202 of FIG. 2. In some embodiments, the mobile application 116 may call and open another mobile application that may be, or may include, the analytics system. In some embodiments, the analytics system may be part of the mobile application 116. An example user interface of the analytics system is illustrated and described in connection with FIG. 11.

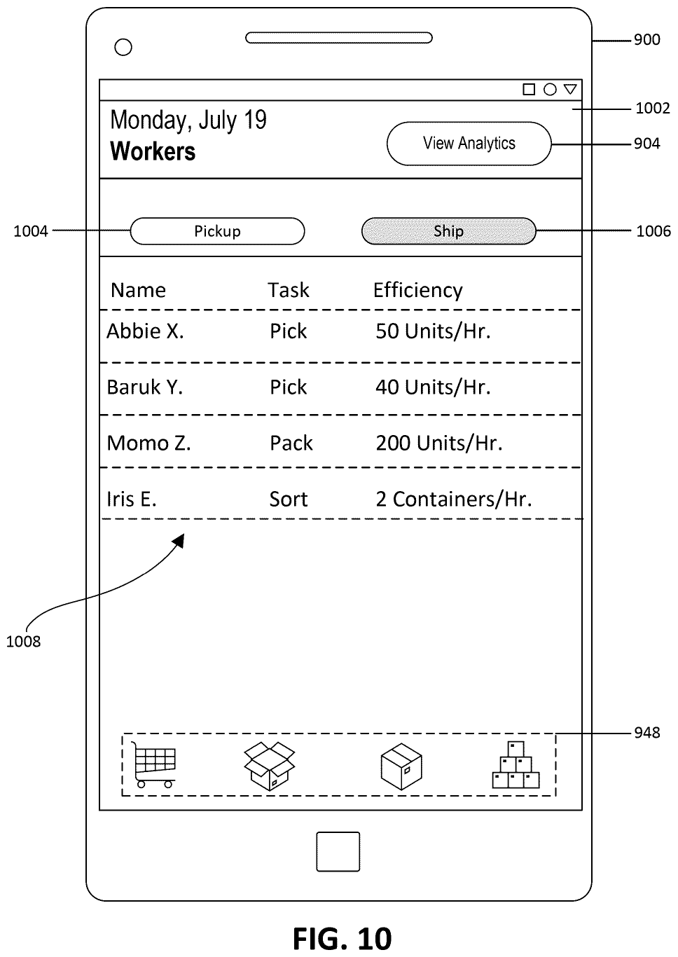

In the example shown, the user interface 902 includes a section 906 for preparing orders for pickup and a section 908 for preparing orders for shipment. Other sections illustrating work required to accomplish other work tasks in addition to preparation of orders may be presented within the user interface 902 as well. Among other things, in the example shown, each of the sections 906-908 may include data related to their respective order preparation processes. For example, the section 906 includes a worker-allocation adjustment 910, which indicates that I worker may be removed from preparing orders for pickup. The section 906 further includes a view workers input field 910. In response to a selection of the view workers input field 910, the mobile application 116 may, in some embodiments, display a user interface displaying worker information (e.g., worker information for workers who are preparing order for pickup). In the example of FIG. 9A, there are 3 workers preparing orders for pickup. An example user interface displaying worker data is illustrated and described below in connection with FIG. 10.

The section 906 further includes two groups of orders, the group 912 and the group 914. Each of the groups 912-914 may correspond with a plurality of orders that must be prepared to be picked up. In the example shown, the group 912 includes a deadline 916, tasks 918, and a view group input field 920. As shown, the deadline 916 may indicate that the orders of the group 912 must be ready for pickup at 12 PM. The tasks 918 may indicate that, of the group 912, there are 105 units ready to be picked and 60 units ready to be put. In some embodiments, one or more of the tasks 918 may be an interactive user interface component. For example, a user may select the “Pick” task to begin working on the pick task or to view data related to the pick task. The mobile application 116 may, in response to a selection of the view group input field 920, display data related to the plurality of orders belonging to the group 912. As shown, the group 914 may include a different plurality of orders than the group 912. The group 914 may also include a deadline 922, tasks 924, and a view group input field 926.

The section 908 includes data related to orders that are to be shipped. The section 908 includes a worker-allocation adjustment 928, which indicates that 2 additional workers are needed for the orders to be prepared on time. The section 908 further includes a view workers input field 930 and two groups of orders 932-934, each of which may include orders that are to be prepared for shipment. The group 932 includes a deadline 936, tasks 938, and a view group input field 940. The group 934 includes a deadline 942, tasks 944, and a view group input field 946. As illustrated by the deadline 942, a deadline for a group of orders may, in some instances, be on a day other than the current day. As described above in connection with the tasks 918, each of the tasks 938 and 944 may include selectable fields for viewing or working on a task. Thus, in some embodiments, an additional worker may select, for example, the “Pick” task of the tasks 938 to begin working on the pick task for the group 932 of orders, thereby becoming one of the two required additional workers to timely prepare orders for shipment.

In some embodiments, the mobile application 116 may temporarily deactivate one or more interactive components associated with one or more tasks of the tasks 918, 924, 938, and 944. As an example, the mobile application 116 may deactivate one or more of the input fields for the tasks in the tasks 944, thereby blocking a worker from beginning to work on any of the tasks 944. A task may be deactivated, for example, because there is higher priority work that needs attention, because a deadline for completing work of the task is sufficiently far in the future (e.g., a task is not required to be completed for three or four hours or until the next day), or because a manager or administrator elected to deactivate the task. In some embodiments, fewer than all of the tasks 944 may be deactivated (e.g., a worker may be able to select the “Package” task but may be blocked from selecting the “Pick” task). In some embodiments, the deactivated tasks may be grayed out or may include another indication that they are not selectable, while also still displaying work that is associated with the deactivated task

In some embodiments, the mobile application 116 may, despite deactivating an option to select some tasks, keep active or activate an option select other tasks. As an example in FIG. 9A, an option to select the tasks 944 may be deactivated, but a worker may be able to select the tasks 938. As a result, a worker preparing orders for shipment may be required to select one of the tasks 938, which may have a higher priority than the tasks 944. Thus, the mobile application 116 may, by selectively activating and deactivating input fields associated with starting tasks based on task priority, provide a mechanism for prioritizing which tasks receive worker attention.

Furthermore, in some embodiments, the mobile application 116 may, in response to a selection of a task, prioritize the work within a task that a worker receives. For example, when a worker selects the “Pick” task of the tasks 938, then the worker may be automatically assigned to pick one or more high priority units of the 105 available units. For example, the worker may be assigned to pick a batch of 20 units that need to be ready to ship before other units. Thus, the mobile application 116 may not only prioritize which tasks a worker begins (e.g., by selective activating/deactivating tasks that workers may select), but also may prioritize work within selected tasks (e.g., by automatically assigning high priority to work to a worker).

In the example shown, the user interface 902 includes icons 948. In some embodiments, each of the icons 948 may be associated with a task for preparing orders. For example, the icons 948 may include an icon for one or more of a picking task, a preparing task, a packaging task, a putting task, a sorting task, a transportation task, or another task related to fulfilling orders. In some embodiments, each of the icons 948 may be a button or link that, when selected, causes the mobile application 116 to display data related to a task (e.g., selecting the cart icon may display data related to a Pick task or may direct the user to a system for performing the pick task).

FIG. 9B illustrates an example user interface 903 of the mobile application 116. In some embodiments, the user interface 903 may display aspects of work data for a location. In some embodiments, aspects of the user interface 903 may be displayed in addition to, or instead of, the user interface 902. In the example shown, the user interface 903 includes a section 905 for preparing orders for pickup. The section 905 includes a worker-allocation adjustment 907, which indicates that the location is on pace to prepare orders for pickup on time. The section 905 further includes a view workers input field 909. In response to a selection by a user of the view workers input field 909, the mobile application 116 may, in some embodiments, display information related to four workers who are currently working on tasks for preparing orders for pickup.

In the example of FIG. 9B, the section 905 includes a plurality of tasks 911a-d related to preparing orders for pickup. In the example shown, the tasks 911a-d include grocery, merchandise, put, and return. The grocery task 911a and the merchandise task 911b may include, for example, picking items from shelves or another location and bringing them to a subsequent location. In some embodiments, the grocery task 911a may be for grocery items whereas the merchandise task 911b may be for non-grocery items. In some embodiments, one or more of the grocery task 911a or the merchandise task 911b may also include tasks other than picking items. The put task 911c may include organizing or putting items in a location to be picked up. The return task 911d may include returning items to shelves or other locations if the items were not picked up. As shown, there may be three batches that are available to be worked for each of the grocery task 911a and the merchandise task 911. As described above (for example in connection with the order aggregator 302 of FIG. 3), the work coordination tool 108 may, in some embodiments, group one or more orders or items into batches. For the grocery task 911a, details related to the three available batches are illustrated in the grocery batch details 917. For the merchandise task 911b, details related to the three available batches are illustrated in the merchandise batch details 919. As shown, each batch may include a time remaining and an amount of work, which may be items of orders that need to be picked.

The user interface 903 further includes the input fields 913a-c and the text 915. In some embodiments, a user may select one of the input fields 913a-c to begin working on a corresponding task. In the example shown, the text 915 indicates that there is not any work available for the put task 911c. As a result, the user interface 903 may not, in some embodiments, provide an input field—or may deactivate an input field—for a worker to begin working on the put task, thereby prioritizing tasks that have available work. As an illustrative example, a user may select the input field 913a to begin working on one or more of the three batches that are available for the grocery task 911a. As illustrated, the input field 913a may indicate (e.g., with a number in parenthesis or by another indicator, such as a color or notification) that one of the batches associated with the grocery task 911a is a priority, because it is scheduled to be finished within relatively soon amount of time (e.g., an hour). In some embodiments, when a worker selects the input field 913a, the worker is automatically assigned to one of the batches of the task 911a. In some examples, the worker may be assigned to a batch based on a priority order of the batches (e.g., assigned to the batch with 51 minutes remaining and 21 units of work). The priority order may be based on a deadline (e.g., the batch with the next deadline time is automatically assigned), based on characteristics of items within a batch (e.g., it may be determined that an order having a certain promotional or expensive item has priority), or based on another item or batch characteristic. Similarly, in response to a worker selecting the input field 913b or the input field 913c, the worker may be automatically assigned to a batch of the merchandise task 911b or one or more units of the return task 911d, respectively. In some embodiments, a group of orders or a batch may itself have an order regarding how the task is to be carried out. For example, for a task to pick a batch having 21 units, there may be an order, or a suggested order, in which the 21 units are to be picked.

FIG. 10 illustrates an example user interface 1002 of the mobile application 116. In the example shown, the mobile application is running on the mobile device 900. In some embodiments, the mobile application 116 may display the user interface 1002 in response to a user selection of a view worker input field of the user interface 902. In the example shown, the user interface 1002 includes the view analytics input field 904, order preparation process toggle buttons 1004-1006, worker efficiency data 1008, and the icons 948.

In some embodiments, a user may use the user interface 1002 to view worker data for both workers preparing orders for pickup and workers preparing orders for shipment. In some embodiments, the worker may use the toggle buttons 1004-1006 to select which of the groups of workers to view. In the example of FIG. 10, a user selects the toggle button 1006 and, in response, the user interface 1002 displays worker data for workers preparing orders for shipment, as illustrated by the worker efficiency data 1008. In the example shown, the worker efficiency data 1008 includes workers who are working on tasks for preparing orders for shipment and includes data related to those workers.

FIG. 11 illustrates an example user interface 1102 of an analytics system. In some embodiments, the mobile application 116 may display the user interface 1102. In some embodiments, the mobile application 116 may be communicatively coupled to a system that displays the user interface 1102. In some embodiments, the user interface 1102 may be displayed in response to a selection of the view analytics input field 904. In the example shown, the user interface 1102 is displayed on a screen of the device 900.

In the example shown, the user interface 1102 includes the view analytics input field 904, the toggle buttons 1004-1006, forecasted work 1103, a data illustration 1104, workflow data 1106, data metrics 1108, a data table 1110, and icons 1112. As illustrated, the user interface 1102 displays data related to orders that are to be shipped in response to a selection of the toggle button 1006. In some embodiments, the user interface 1102 may display aspects of work data generated by the work coordination tool 108.

In some embodiments, the forecasted work 1103 may indicate how many units are to be prepared at a location. In some embodiments, the forecasted work 1103 may be a combination of actual work and of predicted work. In some embodiments, the forecasted work 1103 may be for a particular order preparation process (e.g., preparing orders for shipment, as shown in the example of FIG. 11). In some embodiments, the forecasted work 1103 may be for current workday or for another period of time (e.g., a 24-hour span or a week). The data illustration 1104 and the workflow data 1106 may show a status of orders. In the example shown, the status may be for orders that are to be shipped on the current workday. As shown, the data illustration 1104 and the workflow data may illustrate late work, carryover work (e.g., work received from the previous day or work that was received overnight), today's work, and completed work. The data metrics 1108 may include one or more data metrics related to order fulfillment. In some embodiments, the data metrics 1108 may be specific to a location. In some embodiments, the data metrics may include a productivity of one or more tasks (e.g., as measured by efficiency or another measure of productivity), a metric related to errors or issues when performing tasks (e.g., a percentage of items that were not found when picking items), an on-time percentage, and an average amount of time that a customer or carrier waits to receive one or more items. Depending on the embodiments, the metrics of the data metrics 1108 may vary.

The data table 1110 may include data related to order fulfillment at a location. In the example of FIG. 11, the data table includes data related to units that must be processed as part of preparing orders for shipment, and the data table also includes how many worker hours are scheduled for working on tasks of preparing orders to be shipped. The user interface 1102 further includes icons 1112, each of which may be associated with one or more components of an analytics system. For example, the icons 1112 may be related to making notes, viewing other data metrics, viewing notifications, or performing one or more operations on data of the data analytics system. In some embodiments, one or more of the icons 1112 may be selected by a user to access a component of the analytics system associated with the icon.

FIG. 12 illustrates a user interface 1202 of an order preparation system. In some embodiments, the order preparation system may be one of the order preparation systems 204a-x described above in connection with FIG. 2. In some embodiments, the order preparation may be part of the mobile application 116, or it may be a separate application that is communicatively coupled with the mobile application 116. In some embodiments, the order preparation system may be running on the mobile device 900. In some embodiments, the order preparation system illustrated in the example of FIG. 12 may facilitate a worker's selection of a task to begin working on. In some embodiments, the mobile application 116 may cause the user interface 1202 to be displayed in response to a selection of task displayed in the user interface 902.

The user interface 1202 includes the toggle buttons 1004-1006. In some embodiments, a worker may select the toggle button 1004 to view and select tasks for preparing orders to be picked up. In some embodiments (e.g., in the example of FIG. 12), a worker may select the toggle button 1006 to view and select tasks for preparing orders to be shipped. The user interface 1202 further includes the tasks 1204-1210. Each of the tasks 1204-1210 may be related to a task for preparing orders to be shipped. Furthermore, each of the tasks 1204-1210 may include data related to work of that task (e.g., how many units of work must currently be completed for that task). Furthermore, one or more of the tasks 1204-1210 may indicate whether more or fewer workers are required for that task to prepare orders on time. Furthermore, one or more of the tasks may include an input that, when selected, may allow a user to begin working on that task. In some embodiments, the user may be directed to a system or user interface for completing a task that the user selected, as illustrated in the example user interface of FIG. 13.

FIG. 13 illustrates a user interface 1302 of an order preparation system. In the example shown, the order preparation system shown (which may be one of the order preparation systems 204a-x) may be used to select or perform work as part of a pick task. In some embodiments, the user interface 1302 may be displayed in response to a selection of an input field of the task 1204 of FIG. 12. In some embodiments, the user interface 1302 may be displayed in response to a selection of a component of the user interface 902. In some embodiments, other user interfaces may be displayed for performing other tasks (e.g., a packing, sorting, putting, or other task). The user interface 1302 includes the toggle buttons 1004-1006, which a worker may select depending on whether the worker is performing a pick task as part of preparing orders for pickup or as part of preparing orders for shipment. In the example shown, the user interface 1302 may also include available work 1304. In some embodiments, the available work 1304 may include assignable or selectable groups of items that may be picked (or, in other instances, packed, sorted, put, etc.). In the example shown, the available work 1304 includes an option to select a group (e.g., a check box), a time until the work is due, and details of items (e.g., how many unique items are in the group and how many total items are in the group). In other embodiments, the available work 1304 may include other data. The user interface 1302 may further include a start task input field 1306 that, when selected, may cause selected work to be assigned to the worker (e.g., the group 3 of items may be assigned to the worker to pick).

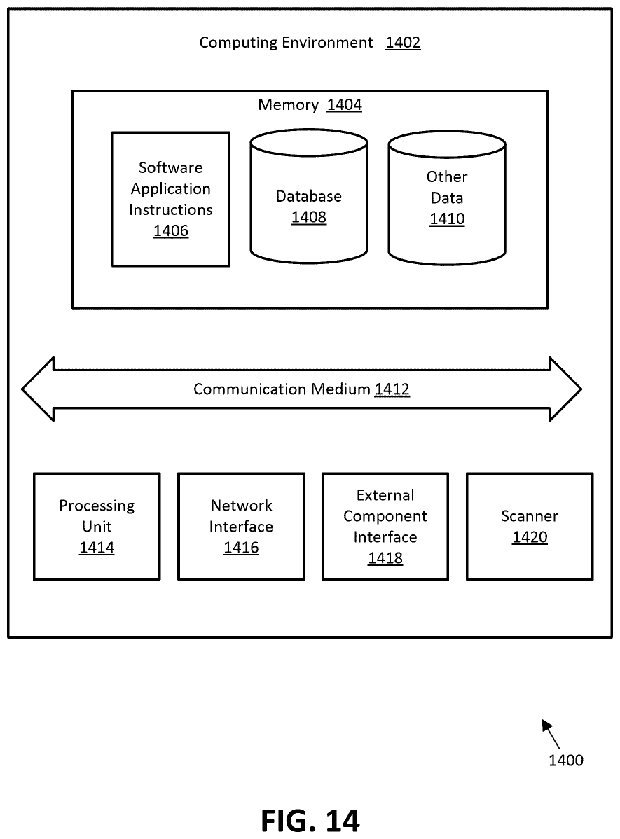

FIG. 14 illustrates an example system 1400 with which disclosed systems and methods can be used. In an example, the following can be implemented in one or more systems 1400 or in one or more systems having one or more components of system 1400: the databases 102-106, the work coordination tool 108, the mobile devices 114, the mobile application 116, the analytics system 202, the order preparation systems 204a-x, the order aggregator 302, the order forecaster 304, the efficiency calculator 306, the worker adjustment calculator 310, the work-data generator 312, the mobile application interface 314, the event handler 316, the mobile device 318, the mobile device 900, and other aspects of the present disclosure.

In an example, the system 1400 can include a computing environment 1402. The computing environment 1402 can be a physical computing environment, a virtualized computing environment, or a combination thereof. The computing environment 1402 can include memory 1404, a communication medium 1412, one or more processing units 1414, a network interface 1416, an external component interface 1418, and a scanner 1420.

The memory 1404 can include a computer readable storage medium. The computer storage medium can be a device or article of manufacture that stores data and/or computer-executable instructions. The memory 1404 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

The memory 1404 can store various types of data and software. For example, as illustrated, the memory 1404 includes software application instructions 1406, one or more databases 1408, as well as other data 1410. The communication medium 1412 can facilitate communication among the components of the computing environment 1402. In an example, the communication medium 1412 can facilitate communication among the memory 1404, the one or more processing units 1414, the network interface 1416, the external component interface 1418, and the scanner 1420. In some embodiments, the software application instructions 1406 may include instructions for processing visual data captured by the scanner 1420. The communications medium 1412 can be implemented in a variety of ways, including but not limited to a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communications medium.

The one or more processing units 1414 can include physical or virtual units that selectively execute software instructions, such as the software application instructions 1406. In an example, the one or more processing units 1414 can be physical products comprising one or more integrated circuits. The one or more processing units 1414 can be implemented as one or more processing cores. In another example, one or more processing units 1414 are implemented as one or more separate microprocessors. In yet another example embodiment, the one or more processing units 1414 can include an application-specific integrated circuit (ASIC) that provides specific functionality. In yet another example, the one or more processing units 1414 provide specific functionality by using an ASIC and by executing computer-executable instructions.

The network interface 1416 enables the computing environment 1402 to send and receive data from a communication network. The network interface 1416 can be implemented as an Ethernet interface, a token-ring network interface, a fiber optic network interface, a wireless network interface (e.g., Wi-Fi), or another type of network interface.

The external component interface 1418 enables the computing environment 1402 to communicate with external devices. For example, the external component interface 1418 can be a USB interface, Thunderbolt interface, a Lightning interface, a serial port interface, a parallel port interface, a PS/2 interface, or another type of interface that enables the computing environment 1402 to communicate with external devices. In various embodiments, the external component interface 1418 enables the computing environment 1402 to communicate with various external components, such as external storage devices, input devices, speakers, modems, media player docks, other computing devices, scanners, digital cameras, and fingerprint readers.

The scanner 1420 may capture visual information external to the system 1400. For example, if aspects of a mobile device are implemented using components of the system 1400, then the scanner 1420 may capture visual data (e.g., photos, scans, light-based data, shade-based data) that may be proximate to the mobile device. In some embodiment, the scanner 1420 may include a camera. In some embodiments, the scanner 1420 may be part of an optical scanning system. In some embodiments, the scanner 1420 may convert, or a component coupled to the scanner 1420 may convert, visual data to other types of data, such as binary data or alpha-numeric characters.

Although illustrated as being components of a single computing environment 1402, the components of the computing environment 1402 can be spread across multiple computing environments 1402. For example, one or more of instructions or data stored on the memory 1404 may be stored partially or entirely in a separate computing environment 1402 that is accessed over a network.

Depending on the size and scale of the computing environment 1402, it may be advantageous to include one or more load balancers to balance traffic across multiple physical or virtual machine nodes. Each node may be configured to be capable of running the full system 1400, such that portal can run and schedule jobs and serve the portal user interface as long as a single node remains functional. The environment 1402 may include monitoring technology to determine when a node is not functioning so an appropriate action can be taken.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A method for coordinating worker activity, the method comprising:
receiving, at a work coordination tool associated with an enterprise, worker data for a plurality of workers at a location, the worker data including worker activity data that is automatically generated in response to optical scans of items being captured during performance of tasks by the plurality of workers;
receiving, at the work coordination tool, task data associated with the location, the task data including order data including a plurality of orders to be fulfilled at the location, wherein an order of the plurality of orders is associated with an order preparation process;
based at least in part on the worker data, calculating, at the work coordination tool, a worker efficiency for a task of the order preparation process;
based at least in part on the worker efficiency and the order data, generating, at the work coordination tool, a worker-allocation adjustment; and
based on the worker-allocation adjustment resulting in a recommended adjustment to a number of workers performing the task, automatically sending, from the work coordination tool, the worker-allocation adjustment to a mobile application installed on a mobile device associated with a worker of the plurality of workers.

2. The method of claim 1, wherein automatically sending, from the work coordination tool, the worker-allocation adjustment to the mobile application installed on the mobile device associated with the worker of the plurality of workers causes the mobile application to automatically display a notification including the worker-allocation adjustment on a screen of the mobile device.

3. The method of claim 1, wherein at least some of the optical scans of items are captured by a scanner of the mobile device.

4. The method of claim 1, wherein the order preparation process is one of preparing the order for pickup or preparing the order for shipment.

5. The method of claim 1, wherein the location is a retail store.

6. The method of claim 1,
wherein the order preparation process includes a plurality of tasks, the plurality of tasks including the task; and
wherein the task is one or more of picking items, packaging items, or transporting items.

7. The method of claim 1, wherein calculating the worker efficiency comprises, for a worker of the plurality of workers:
determining, using the worker activity data, a number of units completed by the worker; and
dividing the number of units completed by the worker by an elapsed time.

8. The method of claim 1, further comprising grouping one or more orders of the plurality of orders based on the order preparation process of the one or more orders of the plurality of orders.

9. The method of claim 1, wherein generating the worker-allocation adjustment comprises:
determining whether an order preparation process for a group of orders of the plurality of orders will be completed by a deadline; and
in response to determining that the order preparation process for the group of orders of the plurality of orders will not be completed by the deadline, setting the worker-allocation adjustment to indicate that one or more additional workers are required.

10. The method of claim 1, further comprising:
receiving updated order data, the updated order data including one or more new orders;
based on the worker data and the updated order data, generating an updated worker-allocation adjustment; and
after generating the updated worker-allocation adjustment, automatically sending the updated worker-allocation adjustment to the mobile application;
wherein the updated order data is automatically generated in response to a customer placing the one or more new orders with an online ordering system.

11. The method of claim 1, further comprising:
receiving updated worker activity that is automatically generated in response to additional optical scans of items being captured during performance of tasks by the plurality of workers;
based on the updated worker activity data, calculating, at the work coordination tool, an updated worker efficiency for the task of the order preparation process;
based at least in part on the updated worker efficiency, generating an updated worker-allocation adjustment; and
after generating the updated worker-allocation adjustment, automatically sending the updated worker-allocation adjustment to the mobile application.

12. The method of claim 1, wherein the worker-allocation adjustment changes a current task of the worker from a task of the task data that is unrelated to the order preparation process to the task of the order preparation process.

13. A system for coordinating work comprising:
a work coordination tool associated with an enterprise, wherein the work coordination tool comprises a processor and memory;
wherein the work coordination tool is communicatively coupled to a mobile application installed on a mobile device associated with a worker of a plurality of workers at a location;
wherein the memory includes instructions that, when executed by the processor, cause the work coordination tool to:
receive worker data for the plurality of workers at the location, the worker data including worker activity data that is automatically generated in response to optical scans being captured during performance of tasks by the plurality of workers;
receive task data associated with the location, the task data including order data including a plurality of orders to be fulfilled at the location, wherein an order of the plurality of orders is associated with an order preparation process;
based at least in part on the worker data, calculate a worker efficiency for a task of the order preparation process;
based at least in part on the worker efficiency and the order data, generate a worker-allocation adjustment; and
based on the worker-allocation adjustment resulting in a recommended adjustment to a number of workers performing the task, automatically send the worker-allocation adjustment to the mobile application.

14. The system of claim 13,
further comprising a plurality of mobile devices having the mobile application installed thereon, the plurality of mobile devices including the mobile device;
wherein the plurality of mobile devices are associated with the plurality of workers; and
wherein the instructions, when executed by the processor, cause the work coordination tool to send the worker-allocation adjustment to each of the plurality of mobile devices.

15. The system of claim 13,
wherein the location is a retail store; and
wherein the order preparation process is one of preparation for pickup or preparation for shipment.

16. The system of claim 13,
wherein the mobile device comprises a second processor and second memory;
wherein the second memory includes second instructions that, when executed by the second processor, cause the mobile application to:
receive the worker-allocation adjustment from the work coordination tool; and
display a user interface comprising the worker-allocation adjustment;
wherein the user interface comprises a plurality of input fields, the plurality of input fields including an input field for selecting the task of the order preparation process.

17. The system of claim 13,
further comprising an order preparation system communicatively coupled to the mobile application;
wherein the mobile application, in response to receiving a user input via a user interface, causes the mobile device to display a second user interface associated with the order preparation system.

18. A method for coordinating work, the method comprising:
receiving, at a work coordination tool, worker data for a plurality of workers at a location, the worker data including worker activity data that is automatically generated in response to optical scans of items being captured during performance of tasks by the plurality of workers;
receiving, at the work coordination tool, order data, the order data including a plurality of orders, wherein an order of the plurality of orders includes one or more items and is associated with an order preparation process;
grouping the plurality of orders into a first group of orders associated with a first order preparation process and second group of orders associated with a second order preparation process;
based at least in part on the worker activity data, calculating, at the work coordination tool, a first worker efficiency for a first task of the first order preparation process and a second worker efficiency for a second task of the second order preparation process;
based at least in part on the first worker efficiency, generating a first worker-allocation adjustment for the first order preparation process;
based at least in part on the second worker efficiency, generating a second worker-allocation adjustment for the second order preparation process; and
based on the first worker-allocation adjustment resulting in a recommended adjustment to a number of workers performing the first task, automatically sending work data to a mobile application installed on a mobile device associated with a worker of the plurality of workers, the work data including the first worker-allocation adjustment and the second worker-allocation adjustment.

19. The method of claim 18,
wherein the first order preparation process is preparation for pickup;
wherein the second order preparation process is preparation for shipment;
wherein the first order preparation process includes a first plurality of tasks; and
wherein the second order preparation process includes a second plurality of tasks.

20. The method of claim 19, wherein the location is a retail store.
